(19) United States
(12) Patent Application Publication
(10) Pub. No.: US 2003/0036854 A1
(43) Pub. Date: Feb. 20, 2003

(54) Apparatus and method for designing proteins and protein libraries

(75) Inventor: John R. Desjarlais, Pasadena, CA (US)

Correspondence Address: PAUL D. GREELEY, ESQ., OHLANDT, GREELEY, RUGGIERO & PERLE, L.L.P., 10th FLOOR, ONE LANDMARK SQUARE, STAMFORD, CT, 06901-2682, US

(73) Assignee: The Penn State Research Foundation

(21) Appl. No.: 10/071,859

(22) Filed: Feb. 6, 2002

Related U.S. Application Data
(63) Continuation of application No. 09/877,695, filed on Jun. 8, 2001.
(60) Provisional application No. 60/266,711, filed on Feb. 6, 2001.

(51) Int. Cl. G06F 19/00

(52) U.S. Cl. 702/19

(57) ABSTRACT

Methodology executed by a computer under the control of a program, said computer including a memory for storing said program, said method comprising the steps of inputting an ensemble of protein backbone scaffolds; applying at least one protein design cycle to each of said scaffolds; and generating a probability matrix derived from a plurality of variable sequences.

This application is a Continuation-In-Part of and claims priority from U.S. application Ser. No. 09/877,695, filed on Jun. 8, 2001 and claims priority from U.S. Provisional Application Serial No. 60/266,711 filed on Feb. 6, 2001.

### FIELD OF THE INVENTION

The present invention relates to an apparatus and method for quantitative protein design and automation.

### BACKGROUND OF THE INVENTION

There has been considerable recent success in the development of computational methods for the design of protein sequences, at various degrees of sophistication. Several groups have presented results in which computer algorithms were used to design novel hydrophobic cores for proteins (Dahiyat & Mayo, 1996; Dahiyat & Mayo, 1997b; Desjarlais & Handel, 1995; Hellinga & Richards, 1994; Kono & Doi, 1994; Lazar et al., 1997), in many cases with experimental validation of the proteins by biophysical and/or structural methods (Dahiyat & Mayo, 1996; Dahiyat & Mayo, 1997b; Desjarlais & Handel, 1995; Johnson et al., 1999; Kono et al., 1998; Lazaretal., 1997; Lazaretal., 1999).

Mayo and colleagues have pioneered the development of algorithms for non-core (Dahiyat et al., 1997a) and full sequence design (Dahiyat & Mayo, 1997a; Dahiyat et al., 1997b), using parameterized force fields and sophisticated optimization methods such as the Dead-End Elimination (DEE) theory (Desmet et al., 1992; Goldstein, 1994). These methods were used successfully to design a sequence that adopts the zinc finger fold with no requirement for zinc binding (Dahiyat & Mayo, 1997a). The force fields used for these design processes have been parameterized over time by comparison between the calculated and experimentally determined folding stabilities of the designed proteins, a process referred to as the design cycle (Dahiyat & Mayo, 1996; Gordon et al., 1999; Hellinga, 1997; Street & Mayo, 1999). A patent related to these studies is U.S. Pat. No. 6,188,965, incorporation herein by way of reference.

A significant limitation (and criticism) of extant protein design methodologies is a lack of a generally applicable method for incorporating backbone flexibility into the design simulation. Although some efforts along these lines have been explored (Desjarlais & Handel, 1999; Harbury et al., 1995; Su & Mayo, 1997), they are limited in scope.

A second limitation in many design methods is that they do not provide a comprehensive measure of the sequence space that is consistent with a three-dimensional protein fold. In this context, sequence space means all sequential combinations of amino acids that can spontaneously fold into the target three-dimensional structure. Knowledge of the viable sequence space is a crucial feature of the ability to rationally design protein combinatorial libraries that can be used to search for proteins with improved properties. Again, some efforts along these lines have been pursued, for instance by designing multiple sequences using heuristic (Monte Carlo or genetic algorithm) methods (Dahiyat et al., 1997b; Desjarlais & Handel, 1995; Kuhlman & Baker, 2000). Such methods serve to partially explore the sequence space of a fold, but do not necessarily yield quantitatively robust information. Application of the self-consistent mean field methods (Delarue & Koehl, 1997; Koehl & Delarue, 1994; Lee, 1994) has some promise for exploring sequence space (Voigt et al., 2001), but this class of methods have significant limitations that call into question their ability to fully explore the appropriate space (Voigt et al., 2000). Furthermore, this method has not yet been demonstrated to yield physically viable designed proteins.

In view of the previous discussion of demands and limitations in the field of protein design, it can be seen that there is a need to improve protein design and evaluation methodology. Accordingly, it is an object of the invention to provide a computational protein design procedure that is capable of incorporating backbone flexibility in a general way and is capable of providing a superior exploration of the amino acid sequence space consistent with a protein structural state.

Another object of the invention is to provide a novel approach to the evaluation and parameterization of protein design algorithms that is more efficient than efforts that rely on feedback from experimental stability data alone. Yet another object of the invention is to provide a method of analysis of the ability of protein design algorithms to design amino acid sequences that are similar to those that exist naturally for a given protein class. These and other objects and advantages of the invention and equivalents thereof, are described and provided in the drawings and descriptions that follow and manifest in the appended claims.

### SUMMARY OF THE INVENTION

In accordance with the objects outlined above, the present invention provides methods executed by a computer under the control of a program, the computer including a memory for storing the program. The method comprises the steps of inputting an ensemble of protein backbone scaffolds and pre-filtering a rotamer library to eliminate high energy interactions to form a suitable rotamer set for each scaffold. The method additionally comprises applying a protein design cycle to each of the scaffolds and generating an energy probability matrix comprising a plurality of variable sequences.

The protein design cycle may comprise a sequence prediction algorithm, a dead end elimination algorithm, a genetic algorithm, a Monte Carlo algorithm, or a a self consistent mean field theory (SCMF) algorithm.

The method optionally additionally comprises ranking the variable sequences and/or synthesizing a plurality of the variable sequences. This process may be done reiteratively, using the same or a different protein design cycle, to form additional variable sequences.

The ensemble may comprise a family of naturally occurring proteins, or may be generated by a variety of systems, including a Monte Carlo simulation.

In an additional aspect, the invention provides methods for optimizing simulation or scoring function parameters that utilizes comparisons between designed sequences and natural sequences. The method comprises applying a protein design cycle to produce a variable protein sequence and comparing the variable protein sequence to at least one natural protein sequence and/or conformation. The method additionally comprises modifying the simulation or scoring function parameters to model the comparison.

In a further aspect, the invention provides methods for optimizing simulation or scoring function parameters that utilizes comparisons between designed sequences and natural sequences. The method comprises the steps of applying a protein design cycle to produce an amino acid probability matrix and comparing the matrix to at least one natural protein sequence and/or conformation and modifying the simulation or scoring function parameters to model the comparison.

### BRIEF DESCRIPTION OF THE DRAWINGS

FIG. 1 illustrates a general purpose computer configured in accordance with an embodiment of the invention.

FIG. 2 illustrates processing steps associated with an embodiment of the invention. Repeated application of a protein design algorithm together with processing steps unique to the invention leads ultimately to the creation of designed proteins or combinatorial libraries of proteins.

FIG. 3 illustrates the processing steps associated with a protein design algorithm in accordance with an embodiment of the invention. In particular, FIG. 3 illustrates the use of genetic algorithm optimization of side chains and rotamers, which is implemented at step 54 of FIG. 2 in a preferred embodiment of the invention. The central feature of the genetic algorithm is the cycling between evaluation of side chain and rotamer combinations, and the recombination of models containing different combinations of side chains and rotamers.

FIG. 4 illustrates a protein design parameterization cycle. Repeated application of a protein design algorithm and comparison of the designed proteins to natural sequences is used to optimize simulation parameters.

FIG. 5 illustrates a mean field free energy matrix for a WW domain, generated in accordance with a preferred embodiment of the invention.

FIG. 6 shows circular dichroism (CD) spectra for the designed Ww domain discussed in Example 1. Spectra were collected at 2° C. and 98° C.

FIG. 7 shows a thermal denaturation of the designed Ww domain monitored by CD.

FIG. 8 illustrates the creation of combinatorial libraries using different strategies. FIG. 8A shows a combinatorial library developed by slowly increasing an upper limit on free energy, according to the free energy matrix of FIG. 5, and a library complexity of 10⁵. FIG. 8A shows a combinatorial library developed by slowly increasing an upper limit on free energy, according to the free energy matrix of FIG. 5, and a library complexity of 10⁸. FIG. 8C shows a combinatorial library developed by slowly decreasing a lower limit on probability, according to a probability matrix derived from FIG. 5, and a library complexity of 10⁵.

### DETAILED DESCRIPTION OF THE INVENTION

The present invention relates to the computational design of amino acid sequences that spontaneously adopt a predetermined three-dimensional structure. The target structure is defined by taking the backbone coordinates from the experimentally determined structure of an existing protein, usually, but not always, derived from natural sources. As is further described below, such structures are often readily available in the public domain. The present invention relates to unique developments in the protein design art, leading to improved abilities to incorporate backbone degrees of freedom, and an improved ability to provide a comprehensive view of the space of amino acid sequences consistent with the structure. Accordingly, the present invention provides the capability of designing combinatorial libraries via a probabilistic representation of the space of amino acid sequences that are consistent with the target structure, within preset tolerance levels, such that a diverse set of sequences can be explored. In addition, by using the methods outlined herein, an evaluation of the flexibility of a backbone, as well as the flexibility of rotamer sets, can be evaluated, Furthermore, as long as methods other than deterministic methods are used, the repeated application of heuristic methods results in different results, that can be used to form an energy matrix, that can be evaluated in a variety of ways, such as filtering, ranking, etc.

In the general art of protein design, two components interact throughout a design simulation to produce candidate protein sequences. The first component is a set of one or more scoring functions that evaluate the quality of possible models of the protein. Such models consist of the input backbone structure, a linear sequence of amino acids, and a set of spatial orientations of the amino acids relative to the remainder of the structure. The side chain orientations are often grouped into classes of orientations or conformers called rotamers. The second major component of a design algorithm is an optimization protocol that is used to seek optimal combinations of amino acids and rotamer states as defined by the scoring function.

In addition to these two components, the present invention also provides methods for optimizing the relationship between the various terms in the scoring function, the relationship between the scoring function and the optimization procedure, and the relationship between these components and additional simulation parameters. This is achieved by comparing the features of designed proteins to natural proteins that have similar properties.

The present invention has two broad uses. The most direct application of the invention is the design of a single protein sequence with the goal that the sequence, when produced experimentally, spontaneously adopts the target three-dimensional structure, and has any number of desired properties, including both target (e.g. wild type) properties and/or altered properties.

Secondly, the invention is directed to methods of using the methods of the invention for computational screening of protein sequence libraries to identify either sublibraries or specific proteins with the desired functions. The newly computationally generated proteins can be actually synthesized and experimentally tested in the desired assay, for improved function and properties. Similarly, the library can be additionally computationally manipulated to create a new library which then itself can be experimentally tested. In this embodiment, the invention can be used to prescreen libraries based on known scaffold proteins. That is, computational screening for stability (or other properties) may be done on either the entire protein or some subset of residues, as desired and described below. By using computational methods to generate a threshold or cutoff to eliminate disfavored sequences, the percentage of useful variants in a given variant set size can increase, and the required experimental outlay is decreased.

In addition, in this embodiment, the present invention finds use in the screening of random peptide libraries, which are gaining more attention as they can allow the elucidation of signal transduction pathways, identify key target molecules, serve as drugs or drug competitors in drug screening.

Accordingly, generation of random or semi-random sequence libraries of proteins and peptides allows for the selection of proteins (including peptides, oligopeptides and polypeptides) with useful properties.

The sequences in these experimental libraries can be randomized at specific sites only, or throughout the sequence. The number of sequences that can be searched in these libraries grows expontentially with the number of positions that are randomized. Generally, only up to 10¹²-10¹⁵ sequences can be contained in a library because of the physical constraints of laboratories (the size of the instruments, the cost of producing large numbers of biopolymers, etc.). Other practical considerations can often limit the size of the libraries to 10⁶ or fewer. These limits are reached for only 10 amino acid positions. Therefore, only a sparse sampling of sequences is possible in the search for improved proteins or peptides in experimental sequence libraries, lowering the chance of success and almost certainly missing desirable candidates. Because of the randomness of the changes in these sequences, most of the candidates in the library are not suitable, resulting in a waste of most of the effort in producing the library.

However, using the automated protein design techniques outlined below, virtual libraries of protein sequences can be generated that are vastly larger than experimental libraries. Up to 10⁸⁰ candidate sequences can be screened computationally and those that meet design criteria which favor stable and functional proteins can be readily selected. An experimental library consisting of the favorable candidates found in the virtual library screening can then be generated, resulting in a much more efficient use of the experimental library and overcoming the limitations of random protein libraries.

Two principle benefits come from the virtual library screening: (1) the automated protein design generates a list of sequence candidates that are favored to meet design criteria; it also shows which positions in the sequence are readily changed and which positions are unlikely to change without disrupting protein stability and function. An experimental random library can be generated that is only randomized at the readily changeable, non-disruptive sequence positions. (2) The diversity of amino acids at these positions can be limited to those that the automated design shows are compatible with these positions. Thus, by limiting the number of randomized positions and the number of possibilities at these positions, the number of wasted sequences produced in the experimental library is reduced, thereby increasing the probability of success in finding sequences with useful properties.

In addition, by computationally screening very large libraries of mutants, greater diversity of protein sequences can be screened (i.e. a larger sampling of sequence space), leading to greater improvements in protein function. Further, fewer mutants need to be tested experimentally to screen a given library size, reducing the cost and difficulty of protein engineering. By using computational methods to pre-screen a protein library, the computational features of speed and efficiency are combined with the ability of experimental library screening to create new activities in proteins for which appropriate computational models and structure-function relationships are unclear.

Similarly, novel methods to create secondary libraries derived from very large computational mutant libraries allow the rapid testing of large numbers of computationally designed sequences.

In addition, as is more fully outlined below, the libraries may be biased in any number of ways, allowing the generation of libraries that vary in their focus; for example, domains, subsets of residues, active or binding sites, surface residues, etc., may all be varied or kept constant as desired.

In general, as more fully outlined below, the invention can take on a wide variety of configurations. Preferred embodiments are shown in the figures and described below.

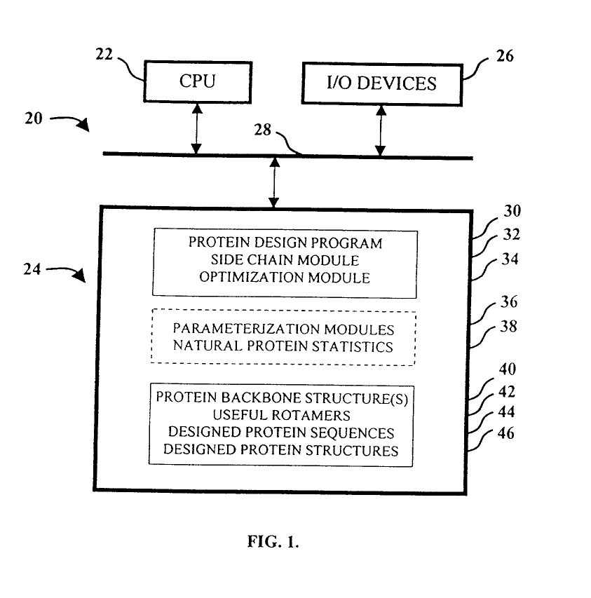

FIG. 1 illustrates an automated protein design apparatus 20 in accordance with an embodiment of the invention. The apparatus 20 includes a central processing unit 22 which communicates with a memory 24 and a set of input/output devices (e.g. keyboard, mouse, monitor, printer, etc.) 26 through a bus 28. The general interaction between a central processing unit 22, a memory 24, input/output devices 26, and a bus 28 is known in the art. The present invention is directed toward the automated protein design program 30 stored in the memory 24.

The automated protein design program 30 may be implemented with a side chain module 32. As discussed in detail below, the side chain module establishes a set of useful rotamers for a selected protein backbone structure. The protein design program 30 may also be implemented with an optimization module 34 that analyzes the interaction of rotamers with the protein backbone structure to generate optimal or near-optimal protein sequences. The protein design program 30 may also include a parameterization module 36 that is used to compare designed proteins to natural proteins such that the design program can be further optimized.

The memory 24 also stores one or a set of protein backbone structures 40, which is downloaded by a user through the input/output devices 26. The memory 24 also stores information on useful rotamers 42 derived by the side chain module 32. In addition, the memory 24 stores designed protein sequences 44, structures of designed proteins 46. Furthermore, the memory 24 stores natural protein statistics 38 for use by the parameterization module 36.

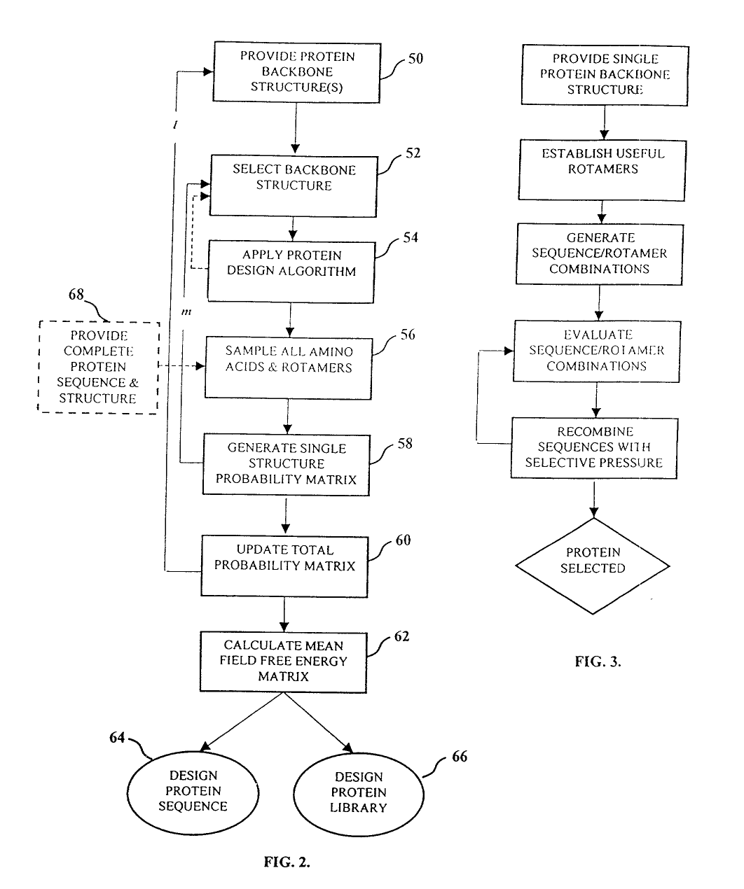

The operation of the automated protein design apparatus 20 is further detailed in FIG. 2, which illustrates the processing steps executed in accordance with the method of the invention. Most of the processing steps are executed by the protein design program 30.

Accordingly, the present invention provides methods for computationally generating one or a plurality of variant proteins. By “protein” herein is meant at least two amino acids linked together by a peptide bond. As used herein, protein includes proteins, oligopeptides and peptides. The peptidyl group may comprise naturally occurring amino acids and peptide bonds, or synthetic peptidomimetic structures, i.e. “analogs”, such as peptoids (see Simon et al., PNAS USA 89(20):9367 (1992)). The amino acids may either be naturally occurring or non-naturally occurring; as will be appreciated by those in the art, any structure for which a set of rotamers is known or can be generated can be used as an amino acid. The side chains may be in either the (R) or the (S) configuration. In a preferred embodiment, the amino acids are in the (S) or L-configuration.

The scaffold protein may be any protein for which a three dimensional structure is known or can be generated; that is, for which there are three dimensional coordinates for each atom of the protein. Generally this can be determined using X-ray crystallographic techniques, NMR techniques, de novo modelling, homology modelling, ab initio structure prediction, etc. In general, if X-ray structures are used, structures at 2A resolution or better are preferred, but not required.

The scaffold proteins may be from any organism, including prokaryotes and eukaryotes, with enzymes from bacteria, fungi, extremeophiles such as the archebacteria, insects, fish, animals (particularly mammals (rodents, primates and particularly human)) and birds are all possible.

Thus, by “scaffold protein” herein is meant a protein for which one or more variants are desired. As will be appreciated by those in the art, any number of scaffold proteins find use in the present invention. Specifically included within the definition of “protein” are fragments and domains of known proteins, including functional domains such as enzymatic domains, binding domains, etc., and smaller fragments, such as turns, loops, etc. That is, portions of proteins may be used as well. In addition, “protein” as used herein includes proteins, oligopeptides and peptides. In addition, protein variants, i.e. non-naturally occuring protein analog structures, may be used.

Suitable proteins include, but are not limited to, industrial and pharmaceutical proteins, including ligands, cell surface receptors, antigens, antibodies, cytokines, hormones, transcription factors, signaling modules, cytoskeletal proteins and enzymes. Suitable classes of enzymes include, but are not limited to, hydrolases such as proteases, carbohydrases, lipases; isomerases such as racemases, epimerases, tautomerases, or mutases; transferases, kinases, oxidoreductases, and phophatases. Suitable enzymes are listed in the Swiss-Prot enzyme database. Suitable protein backbones include, but are not limited to, all of those found in the protein data base compiled and serviced by the Research Collaboratory for Structural Bioinformatics (RCSB, formerly the Brookhaven National Lab).

Specifically, preferred scaffold proteins include, but are not limited to, those with known structures (including variants) including cytokines (IL-1ra (+receptor complex), IL-1 (receptor alone), IL-1a, IL-1b (including variants and or receptor complex), IL-2, IL-3, IL-4, IL-5, IL-6, IL-8, IL-10, IFN-β, INF-γ, IFN-α-2a; IFN-α-2B, TNF-α; CD40 ligand (chk), Human Obesity Protein Leptin, Granulocyte Colony-Stimulating Factor, Bone Morphogenetic Protein-7, Ciliary Neurotrophic Factor, Granulocyte-Macrophage Colony-Stimulating Factor, Monocyte Chemoattractant Protein 1, Macrophage Migration Inhibitory Factor, Human Glycosylation-Inhibiting Factor, Human Rantes, Human Macrophage Inflammatory Protein 1 Beta, human growth hormone, Leukemia Inhibitory Factor, Human Melanoma Growth Stimulatory Activity, neutrophil activating peptide-2, Cc-Chemokine Mcp-3, Platelet Factor M2, Neutrophil Activating Peptide 2, Eotaxin, Stromal Cell-Derived Factor-1, Insulin, Insulin-like Growth Factor I, Insulin-like Growth Factor II, Transforming Growth Factor Bl, Transforming Growth Factor B2, Transforming Growth Factor B3, Transforming Growth Factor A, Vascular Endothelial growth factor (VEGF), acidic Fibroblast growth factor, basic Fibroblast growth factor, Endothelial growth factor, Nerve growth factor, Brain Derived Neurotrophic Factor, Ciliary Neurotrophic Factor, Platelet Derived Growth Factor, Human Hepatocyte Growth Factor, Glial Cell-Derived Neurotrophic Factor, (as well as the 55 cytokines in PDB 1112/99)); Erythropoietin; other extracellular signalling moeities, including, but not limited to, hedgehog Sonic, hedgehog Desert, hedgehog Indian, hCG; coaguation factors including, but not limited to, TPA and Factor VIIa; transcription factors, including but not limited to, p53, p53 tetramerization domain, Zn fingers (of which more than 12 have structures), homeodomains (of which 8 have structures), leucine zippers (of which 4 have structures); antibodies, including, but not limited to, cFv; viral proteins, including, but not limited to, hemagglutinin trimerization domain and hiv Gp41 ectodomain (fusion domain); intracellular signalling modules, including, but not limited to, SH2 domains (of which 8 structures are known), SH3 domains (of which 11 have structures), and Pleckstin Homology Domains; receptors, including, but not limited to, the extracellular Region Of Human Tissue Factor Cytokine-Binding Region Of Gp130, G-CSF receptor, erythropoietin receptor, Fibroblast Growth Factor receptor, TNF receptor, IL-1 receptor, IL-1 receptor/IL1ra complex, IL-4 receptor, INF-γ receptor alpha chain, MHC Class I, MHC Class II, T Cell Receptor, Insulin receptor, insulin receptor tyrosine kinase and human growth hormone receptor.

Also included in the definition of pharmaceutical proteins, are soluble proteins that can serve as vehicles for the delivery of immunogenic sequences. Examples of soluble proteins include, but are not limited to, albumins, globulins, other proteins present in the blood and other body fluids, and any other substantially non-immunogenic proteins. By “substantially non-immunogenic proteins” herein is meant any protein that does not elicit an immune response in a subject. Substantially non-immunogenic proteins may be naturally occurring, synthetic, or modified using recombinant techniques known to one of skill in the art. Preferably, soluble proteins used as delivery vehicles include, but are not limited to, Zn-alpha2-glycoprotein (Sanchez, L. M., (1997) Proc. Natl. Acad. Sci., 94:4626-4630; Sanchez, L. M., et al., (1999) Science, 283:1914-1919; both of which are hereby expressly incorporated by reference), human serum albumin (HSA), IgG, and other substantially non-immunogenic proteins.

Specifically, preferred industrial target proteins include, but are not limited to, those with known structures (including variants) including proteases, (including, but not limited to papains, subtilisins), cellulases (including , but not limited to, endoglucanases I, II, and III, exoglucanases, xylanases, ligninases, cellobiohydrolases I, II, and III, carbohydrases (including, but not limited to glucoamylases, α-amylases, glucose isomerases) and lipases.

Specifically, preferred agricultural target proteins include, but are not limited to, those with known structures (including variants) including xylose isomerase, pectinases, cellulases, peroxidases, rubisco, ADP glucose pyrophosphorylase, as well as enzymes involved in oil biosynthesis, sterol biosynthesis, carbohydrate biosynthesis, and the synthesis of secondary metabolites.

In addition to the scaffold protein backbone, the present invention also includes the generation of an ensemble of related protein backbone structures, as outlined more fully below.

By the “protein backbone” of the scaffold protein is meant the three-dimensional coordinates of the nitrogen, alpha-carbon, carbonyl carbon, and the carbonyl oxygen of all or most of the amino acids of the protein (again, as outlined herein, fragments of scaffold proteins may be used in an isolated form, or only part of the protein may be designed using the methods of the present invention).

The protein backbone structure contains at least one variable residue position. As is known in the art, the residues, or amino acids, of proteins are generally sequentially numbered starting with the N-terminus of the protein. Thus a protein having a methionine at it's N-terminus is said to have a methionine at residue or amino acid position 1, with the next residues as 2, 3, 4, etc. At each position, the wild type (i.e. naturally occuring) protein may have one of at least 20 amino acids, in any number of rotamers. By “variable residue position” herein is meant an amino acid position of the protein to be designed that is not fixed in the design method as a specific residue or rotamer, generally the wild-type residue or rotamer.

In a preferred embodiment, all of the residue positions of the protein are variable. That is, every amino acid side chain may be altered in the methods of the present invention. This is particularly desirable for smaller proteins, although the present methods allow the design of larger proteins as well. While there is no theoretical limit to the length of the protein which may be designed this way, there is a practical computational limit.

In an alternate preferred embodiment, only some of the residue positions of the protein are variable, and the remainder are “fixed”, that is, they are identified in the three dimensional structure as being in a set conformation. In some embodiments, a fixed position is left in its original conformation (which may or may not correlate to a specific rotamer of the rotamer library being used). Alternatively, residues may be fixed as a non-wild type residue; for example, when known site-directed mutagenesis techniques have shown that a particular residue is desirable (for example, to eliminate a proteolytic site or alter the substrate specificity of an enzyme), the residue may be fixed as a particular amino acid. Alternatively, the methods of the present invention may be used to evaluate mutations de novo, as is discussed below. In an alternate preferred embodiment, a fixed position may be “floated”; the amino acid at that position is fixed, but different rotamers of that amino acid are tested. In this embodiment, the variable residues may be at least one, or anywhere from 0.1% to 99.9% of the total number of residues. Thus, for example, it may be possible to change only a few (or one) residues, or most of the residues, with all possibilities in between.

In a preferred embodiment, residues which can be fixed include, but are not limited to, structurally or biologically functional residues; alternatively, biologically functional residues may specifically not be fixed. For example, residues which are known to be important for biological activity, such as the residues which form the active site of an enzyme, the substrate binding site of an enzyme, the binding site for a binding partner (ligand/receptor, antigen/antibody, etc.), phosphorylation or glycosylation sites which are crucial to biological function, or structurally important residues, such as disulfide bridges, metal binding sites, critical hydrogen bonding residues, residues critical for backbone conformation such as proline or glycine, residues critical for packing interactions, etc. may all be fixed in a conformation or as a single rotamer, or “floated”.

Similarly, residues which may be chosen as variable residues may be those that confer undesirable biological attributes, such as susceptibility to proteolytic degradation, dimerization or aggregation sites, glycosylation sites which may lead to immune responses, unwanted binding activity, unwanted allostery, undesirable enzyme activity but with a preservation of binding, etc.

Once the set of variable residue positions is identified, processing proceeds as described below. This processing step entails analyzing interactions of the rotamers with each other and with the protein backbone to generate one or more optimized protein sequences. Simplistically, the processing initially comprises the use of a number of scoring functions to calculate energies of interactions of the rotamers, either to the backbone itself or with other rotamers, as is more fully outlined below. That is, a sort of “prefilter” of the rotamer library is done to eliminate unfavorable rotamers.

The present invention is directed to the generation of variant proteins and libraries of variant proteins. By “variant protein” herein is meant a protein that differs from the target scaffold protein in at least one amino acid residue. As will be appreciated by those in the art, the target scaffold may be a wild-type protein, or it may already be a non-naturally occurring protein. By “library” herein is meant a set of sequences (generally related as having the same or similar protein backbones, but not required) ranging from 100 to 10²⁰ sequences, with from about 1000 to 10⁷ being preferred.

Once a scaffold protein is chosen, computational processing is done, as outlined below, to generate either a single sequence or a library of sequences.

As outlined above, a typical protein design algorithm produces a sequence or sequences that are consistent with an input protein backbone structure. The present invention extends the capacity of protein design algorithms such that thermodynamic information from multiple backbone structures can be integrated to provide an improved picture of the viable amino acid sequence space of the protein. Because a typical protein design algorithm is, in a preferred embodiment, an integral feature of the present invention, the features of one typical protein design algorithm are described below. The algorithm, called SPA, comprises a series of steps as illustrated in FIG. 3, utilizing a scoring function, a genetic algorithm, amino acid reference energies, and a side chain module for selection of useful rotamer states. See Raha et al., 2000, expressly incorporated herein by reference in its entirety.

Defining Useful Rotamers. In a preferred embodiment of the invention, a rotamer library is pre-filtered for a given structural template to partially alleviate the enormous combinatorial complexity involved in protein sequence optimization. Filtering is based on steric and solvent effects. The steric filter is straightforward. For a given position, any rotamer that results in an energy of interaction with the backbone structure greater than 20 kcal/mol is rejected. The second filter is designed to prevent the burial of polar groups or the hyper-exposure of nonpolar groups. This filtering stage is performed as follows. Each possible side chain rotamer is placed into a position on the backbone structure. The extent of burial of each of its atoms is then assessed relative to a set of generic side chain centroid coordinates at all other positions, defined at 2.9 Å from the C_atom along a standard geometry C_—C_bond vector. A contact score for each rotamer atom is defined as (Micheletti et al., 1998):

$${C}_{a} = {\sum }_{i = 1}^{chainlength} \frac{1}{1 + {ⅇ}^{{d}_{a , i} - 6.5}}$$

where Cₐ is the contact score for atom a, and d_{a,i} is the distance between atom a and the side chain centroid at position i. Rotamers of side chains containing polar atoms {Asp, Glu, Lys, Asn, Gin, Arg, Ser, Thr, Tyr, Trp} are eliminated when any of their polar atoms have a contact score greater than 5.5 and are incapable of forming hydrogen bonds with the backbone. Rotamers of nonpolar side chains {Phe, lie, Leu, Val, Pro, Trp} are eliminated when any of their atoms have a contact score less than 2.0. These criteria are defined conservatively because of the coarse nature of the definition of burial. Trp side chains are subject to both criteria. Ala and Gly residues are not subject to filtering. The filtered library is stored in memory 24 as a set of useful rotamers 42.

Other methods have used definitions of surface, buried, and boundary positions to generate position-specific subsets of amino acid types (Dahiyat & Mayo, 1997 a; Dahiyat et al., 1997b). The approach described here obviates the need for explicit definition of burial class, in principle allowing appropriate subsets of rotamers from all amino acid types at some positions.

Scoring Function and Geometries. In a preferred embodiment, the Amber potential energy function (Weiner et al., 1984) with the OPLS non-bonded parameters (Jorgensen & Tirado-Rives, 1988) is used as a basis for evaluation of the energies of protein models with different sequences and rotamer combinations. A preferred form of the potential includes most of the terms of the Amber potential: Van der Waals forces, hydrogen bonding, electrostatic, and torsional energies (as will be appreciated by those in the art, the torsional energy is less important when fixed rotamer libraries are used). Solvation scoring functions, as are known in the art, can also be used. Fixed bond lengths and angles (set at the equilibrium values described for the Amber force field) are used for side chain geometries, eliminating the need for bond stretching and angle bending terms. The energy (or score) of a model is therefore calculated as follows:

$$\begin{matrix}E = {\sum }_{torsions} \frac{{V}_{n}}{2} [ 1 + cos ( n χ ) ] + \\ {\sum }_{i} {\sum }_{j > i} 4 ϵ [ {( \frac{σ}{{R}_{i , j}} )}^{12} - {( \frac{σ}{{R}_{i , j}} )}^{6} ] + \\ \frac{{q}_{i} {q}_{j}}{{DR}_{i , j}} + {\sum }_{i} {S}_{i} Δ {A}_{i} + {\sum }_{x = 1}^{20} {n}_{x} {B}_{x}\end{matrix}$$

where Rij is the distance between atoms i and j; _ and _ are the Lennard-Jones parameters related to the radii and well depth, respectively. The first term is a sum over side chain dihedral angles; the second term is a sum of nonbonded (Lennard-Jones) interactions over all atom pairs (side chain-side chain and side chain-backbone); the third term is a sum of electrostatic interactions summed over all charged atom pairs. Scaling factors for the non-bonded and electrostatic terms, and combining rules are those defined for use of the OPLS parameter set. In the current version of the algorithm, no backbone geometries are evaluated. However, as those in the art will appreciate, the backbone energies can be evaluated as well.

The fourth term is used to represent the salvation energetics of the system (Eisenberg & McLachlan, 1986). The salvation free energy of a model structure is determined by summing the products of the atomic solvation parameter and the estimated change in solvent accessible surface area for each atom in the model structure, where the change is relative to an estimate of the average exposure of that atom type in the unfolded state of the protein. The use of atomic solvation parameters is expected to provide an approximation of the true salvation free energy, and has been used effectively for protein design (Gordon et al., 1999). Furthermore, recent theoretical results indicate that despite its simplicity, it can largely reproduce the energetics calculated using more sophisticated methods (Hendsch & Tidor, 1999). In a preferred embodiment, three solvation parameters are used, corresponding to the burial of polar atoms (N,O), the burial of nonpolar atoms (C), and the exposure of nonpolar atoms (C). The first two terms represent conventional use of atomic solvation parameters, relating to the free energy cost of desolvation of polar groups and the strength of the hydrophobic effect, respectively. In a preferred embodiment, the desolvation penalty for the burial of polar atoms is furthermore a function of the extent of participation of the polar atom in a hydrogen bond. In a preferred embodiment, this is assessed using the condition that the distance between the hydrogen atom and the acceptor atom is less than 2.5 Å, and if the following function has a value less than −0.3:

ƒ(θ, φ)=COS²(θ_{D,H,A})COS(φ_{H,A,AA})

where D, H, and A refer to the donor, hydrogen, and acceptor atoms, respectively, and the AA refers to the acceptor antecedent atom. The final term of the solvation function, a penalty factor for exposure of nonpolar surface, has been applied successfully for designing proteins by Mayo and colleagues (Dahiyat et al., 1997b; Gordon et al., 1999), and may be considered to be both an implicit fold-specificity constraint and a solubility constraint.

In a preferred embodiment, the strengths of the salvation parameters are optimized by comparing the properties of designed protein sequences and natural protein statistics and changing the parameters such that the designed proteins have properties similar to natural proteins. This process is described in more detail below.

In addition, as will be appreciated by those in the art, other scoring functions may find use in the present invention, including those listed above, such as hydrogen bonding scoring functions. Van der Waals forces, electrostatic, solvation, etc.

Amino Acid Reference Energies. In a preferred embodiment, a set of correction factors to account for changes in amino acid sequence within the design process has been generated. These factors account for the absence of an explicit reference state in the calculation of the energy of a designed sequence. The factors are referred to as amino acid reference energies or baseline corrections. That is, the processing steps herein may allow certain amino acids to be either over- or under-represented in a designed protein, as compared to a general percentage found in naturally occurring proteins. Thus, correctional factors allow the weighting of the computation towards standard distributions of amino acids. Alternatively, if different areas of sequence space are to be examined, or atypical proteins are desired, the weighting can be away from standard distributions.

In a preferred embodiment, the correction factors depend on composition only. In an alternative embodiment, the correction factors will depend furthermore on structural environment such as secondary structure class. The application of these 20 factors is straightforward, and is of the following form.

$$CC = {\sum }_{x = 1}^{20} {NC}_{x , d} {E}_{x}$$

where C_{x,d} is the fractional composition of amino acid type x in the designed sequence and N is the length of the sequence.

Similarly, other scoring functions can be biased or weighted in a variety of ways. For example, a bias towards or away from a reference sequence or family of sequences can be done; for example, a bias towards wild-type or homolog residues may be used. Similarly, the entire protein or a fragment of it may be biased; for example, the active site may be biased towards wild-type residues, or domain residues towards a particular desired physical property can be done. Furthermore, a bias towards or against increased energy can be generated. Additional scoring function biases include, but are not limited to applying electrostatic potential gradients or hydrophobicity gradients, adding a substrate or binding partner to the calculation, or biasing towards a desired charge or hydrophobicity.

Side Chain Sampling and Optimization. A rotamer library of statistically prevalent combinations of side chain dihedral angles (Dunbrack & Cohen, 1997) is used to guide sampling of side chain identities and orientations in the combinatorial search for low energy structures. As will be appreciated by those in the art, a variety of rotamer libraries may find use in the present invention; for example, the well known Tuffery, Richardson, Dunbrack and Ponder & Richards libraries. It is also possible to mix rotamer libraries.

In a preferred embodiment, additional flexibility is incorporated by adding discrete or randomly chosen increments of +/−15_ to the first two dihedral angles of each library rotamer.

In the present invention, any heuristic or deterministic protein design algorithm (Desjarlais & Clarke, 1998) can be used for performing the combinatorial search of processing step 54. Heuristic methods include genetic algorithms (GA) (Desjarlais & Handel, 1995; Holland, 1992; Lazar et al., 1997) and Monte Carlo searches (Kuhiman & Baker, 2000; Voigt et al., 2000), while deterministic methods include DEE (Dahiyat & Mayo, 1996; Desmet et al., 1992) or Self-Consistent Mean Field Theory (Koehl & Delarue, 1996; Lee, 1994; Voigt et al., 2001).

The SPA utilizes a GA for the optimization, which is applied as outlined in FIG. 3. In a preferred embodiment, an initial population of 300 members is generated by creation of models with side chains at each position sampled randomly from the list of useful rotamers 42. This sampling is biased according to a Boltzmann probability of the rotamer—these probabilities define a selection matrix for the design procedure. In early cycles of the design procedure, the selection matrix can be derived from the side-chain backbone energies alone. In later rounds, the selection matrix can be extracted from the early rounds of the method (see below). The energy of each complete model in the population is calculated according to the scoring function described above.

Once the energy of each model, or variant protein, is calculated, a preferred embodiment performs a recombination between models (“in silico recombination”, also referred to sometimes as “in silico shuffling”). As will be appreciated by those in the art, there are a wide variety of ways to do this, including randomly or selectively.

In a preferred embodiment, a uniform crossover scheme is used. Parent models are selected from a selection matrix weighted according to the Boltzmann probability of the model, calculated from its energy and a temperature that is set at each round according to a predefined diversity value. In a preferred embodiment, this value, defined as the informational entropy of the population, is set to decay linearly from 5.5 to 3.0 throughout the simulation. In a preferred embodiment, a small amount of random mutation at a preferred frequency of 0.04 is used to modify the population generated by crossover of parent models.

Alternatively, a random or pseudo-random recombination occurs, with the computer arbitrarily choosing fragment size and location for cross-over events.

Furthermore, “in silico homologous recombination” can be done as well, where cross-overs are made in areas of high or perfect homology.

Alternatively, targeted recombination may be done, for example recombining functional domains between proteins, etc.

In a preferred embodiment, this cycle of energy evaluation, selective recombination, and mutagenesis is repeated, ranging from 2 to thousands of times, with from about 10 to about 500 being preferred, an at least 100 times being especially preferred. At the conclusion of the simulation, the sequence with the lowest total energy is taken as the designed (or “optimized”) sequence.

However, as will be appreciated by those in the art, the sequence with the lowest total energy need not be the selected sequence, depending on any number of factors. For example, non-optimized sequences close to the lowest energy solution that have certain desirable characteristics (e.g. smaller alterations in functionally important domains, etc.) can be chosen instead.

In addition, once the lowest energy solution has been found, any number of additional sampling methods may be done. For example, a Monte Carlo search may be done to generate a rank-ordered list of sequences in the neighborhood of the lowest energy solution. Monte Carlo searching is a sampling technique to explore sequence space around the global minimum or to find new local minima distant in sequence space. Starting at the solution, random positions are changed to other rotamers, and the new sequence energy is calculated. If the new sequence meets the criteria for acceptance, it is used as a starting point for another jump. After a predetermined number of jumps, a rank-ordered list of sequences is generated. In addition, Boltzman sampling may be done as is known in the art. In addition to the Boltzman and Monte Carlo sampling, there are other sampling techniques that can be used, including simulated annealing. In addition, for all the sampling techniques, the kinds of jumps allowed can be altered (e.g. random jumps to random residues, biased jumps (to or away from wild-type, for example), jumps to biased residues (to or away from similar residues, for example), etc.). Similarly, for all the sampling techniques, the acceptance criteria of whether a sampling jump is accepted can be altered.

In addition to the techniques outlined herein, the present invention is directed to the creation and use of design techniques that allow analysis of multiple backbone states, rather than just one, to sample an even larger amount of possible amino acid sequence space. Thus, the present invention can create an ensemble of related protein backbone structures that are used in the methods of the invention. In general, in this embodiment, an ensemble of protein backbones is made, and the SPA reaction is done on each backbone, with the data being simultaneously accumulated and/or analyzed and/or scored.

Accordingly, a central feature of the present invention is its use to define mean field probabilities or free energy values that represent the viable amino acid sequence space for a protein fold. In contrast to other approaches that yield mean field free energy estimates, this method can readily be applied to multiple backbone states, and does not require the use of a pairwise decomposable scoring function.

It should be emphasized that computational protein design procedures prior to the present invention deal almost exclusively with a fixed backbone structure for input, with few exceptions. The present invention, however, provides a strategy for incorporating information from an ensemble of related backbone structures, taking advantage of the greater diversity of amino acids encouraged by backbone flexibility, and accounting for physically realistic motions of the backbone.

The method approximates free energy values by expansion of states about multiple local minima converged to by a typical protein design algorithm (including an algorithm which designs an amino acid sequence for a given backbone structure) (Raha et al., 2000). These local minima, or ‘nucleated’ states, are assumed to be representative of the most highly populated states of the system. It should be noted that the nucleated state created at step 54 of FIG. 2 can be provided by any protein design algorithm that yields a protein sequence and structure. Protein design algorithms include, but are not limited to, dead end elimination algorithms, genetic algorithms, Monte Carlo algorithms, self consistent mean field theory algorithms and the like, or combinations thereof.

For example, suitable computational methods include, but are not limited to, sequence profiling (Bowie and Eisenberg, Science 253(5016): 164-70, (1991)), rotamer library selections (Dahiyat and Mayo, Protein Sci 5(5): 895-903 (1996); Dahiyat and Mayo, Science 278(5335): 82-7 (1997); Desjarlais and Handel, Protein Science 4: 2006-2018 (1995); Harbury et al, PNAS USA 92(18): 8408-8412 (1995); Kono et al., Proteins: Structure, Function and Genetics 19: 244-255 (1994); Hellinga and Richards, PNAS USA 91: 5803-5807 (1994)); and residue pair potentials (Jones, Protein Science 3: 567-574, (1994); PROSA (Heindlich et al., J. Mol. Biol. 216:167-180 (1990); THREADER (Jones et al., Nature 358:86-89 (1992), and other inverse folding methods such as those described by Simons et al. (Proteins, 34:535-543,1999), Levitt and Gerstein (PNAS USA, 95:5913-5920,1998), Godzik et al., PNAS, V89, PP 12098-102; Godzik and Skolnick (PNAS USA, 89:12098-102, 1992), Godzik et al. (J. Mol. Biol. 227:227-38,1992) and two profile methods (Gribskov et al. PNAS 84:4355-4358 (1987) and Fischer and Eisenberg, Protein Sci. 5:947-955 (1996), Rice and Eisenberg J. Mol. Biol. 267:1026-1038(1997)), all of which are expressly incorporated by reference. In addition, other computational methods such as those described by Koehl and Levitt (J. Mol. Biol. 293:1161-1181 (1999); J. Mol, Biol. 293:1183-1193 (1999); expressly incorporated by reference) can be used to create a protein sequence library which can optionally then be used to generate a smaller secondary library for use in experimental screening for improved properties and function.

In addition, there are computational methods based on forcefield calculations such as SCMF that can be used as well for SCMF, see Delarue et la. Pac. Symp. Biocomput. 109-21 (1997), Koehl et al., J. Mol. Biol. 239:249 (1994); Koehl et al., Nat. Struc. Biol. 2:163 (1995); Koehl et al., Curr. Opin. Struct. Biol. 6:222 (1996); Koehl et al., J. Mol. Bio. 293:1183 (1999); Koehl et al., J. Mol. Biol. 293:1161 (1999); Lee J. Mol. Biol. 236:918 (1994); and Vasquez Biopolymers 36:53-70 (1995); all of which are expressly incorporated by reference. Other forcefield calculations that can be used to optimize the conformation of a sequence within a computational method, or to generate de novo optimized sequences as outlined herein include, but are not limited to, OPLS-AA (Jorgensen, et al., J. Am. Chem. Soc. (1996), v 118, pp 11225-11236; Jorgensen, W. L.; BOSS, Version 4.1; Yale University: New Haven, Conn. (1999)); OPLS (Jorgensen, et al., J. Am. Chem. Soc. (1988), v 110, pp 1657ff; Jorgensen, et al., J Am. Chem. Soc. (1990), v 112, pp 4768ff); UNRES (United Residue Forcefield; Liwo, et al., Protein Science (1993), v 2, pp1697-1714; Liwo, et al., Protein Science (1993), v 2, pp1715-1731; Liwo, et al., J. Comp. Chem. (1997), v 18, pp849-873; Liwo, et al., J. Comp. Chem. (1997), v 18, pp874-884; Liwo, et al., J. Comp. Chem. (1998), v 19, pp259-276; Forcefield for Protein Structure Prediction (Liwo, et al., Proc. Natl. Acad. Sci. USA (1999), v 96, pp5482-5485); ECEPP/3 (Liwo et al., J Protein Chem 1994 May; 13(4):375-80); AMBER 1.1 force field (Weiner, et al., J. Am. Chem. Soc. vi06, pp765-784); AMBER 3.0 force field (U. C. Singh et al., Proc. Natl. Acad. Sci. USA. 82:755-759); CHARMM and CHARMM22 (Brooks, et al., J. Comp. Chem. v4, pp 187-217); cvff3.0 (Dauber-Osguthorpe, et al.,(1988) Proteins: Structure, Function and Genetics, v4, pp3l-47); cff91 (Maple, et al., J. Comp. Chem. v15, 162-182); also, the DISCOVER (cvff and cff91) and AMBER forcefields are used in the INSIGHT molecular modeling package (Biosym/MSI, San Diego Calif.) and HARMM is used in the QUANTA molecular modeling package (Biosym/MSI, San Diego Calif.), all of which are expressly incorporated by reference.

In an alternative embodiment, the nucleated state can be the full sequence and structure of a natural protein as in step 68, inclusive of all of the original side chains in their experimentally determined orientations.

Within the context of each nucleated state, all amino acid types in all rotamer orientations (drawing from one or more rotamer libraries) are sampled and evaluated at step 56 for each position. The total energy of each sampled state is incorporated at step 60 into a running partition function, defined below, assigned to the amino acid/rotamer combination of interest. In a preferred embodiment, the total partition function Q_{A,l,l} for each amino acid/rotamer, summed over multiple nucleated structures, is ultimately converted at step 62 directly into a mean field free energy value using a well known statistical mechanics relation.

In a preferred embodiment, the method combines information derived by designing sequences for an ensemble of related backbone structures provided at step 50, such that the designed sequences correctly sample the provided degrees of freedom in backbone geometry. That is, rather than use one static backbone geometry, the present invention allows the incorporation of backbone flexibility into the modeling process. The advantage of the approach is significant: all amino acids at each position are evaluated multiple times with respect to many high probability environments, thus allowing the sampling of a greater amount of sequence space and expanding the set of allowable sequences.

Thus, the present invention provides for the generation and evaluation of an ensemble or set of related target scaffold protein backbone structures. In this context, “related backbones” can be determined in a wide variety of ways, including, but not limited to, sequence or structural homology analyses as outlined below, building the ensemble based on derivation from common origins, etc. In a preferred embodiment, backbones that average 2 A differences in atom positions, with 1 A being preferred, as used.

In a preferred embodiment, the ensemble of related protein backbone structures provided at step 50 of FIG. 2 is generated (typically 50-100 structures are used, although the number can vary from 2 to thousands, depending on available data sets, computational criteria, etc.) from a high-resolution crystal structure, a high resolution NMR structure, or a high quality comparative model of a known protein.

The individual backbone structures in the ensemble can be generated by Monte Carlo techniques, molecular dynamics simulations, changing backbone dihedral angles, or any number of other sampling methods, using well known techniques.

Alternatively, the backbone ensemble can be derived directly from an ensemble of experimentally determined NMR structures, a set of structures taken from distinct members of a protein family, or a set of structures determined separately for the same protein. In addition, combinations of direct ensembles and generated ensembles can be produced; for example, a small set of related protein backbone structures can each be used in a sampling system to provide a larger set.

For each individual structure, a protein design algorithm is applied at step 54 to generate a set of side chain identities and rotamer orientations that are optimal (or near optimal) for the structure. Each new structure/sequence combination is treated as a “nucleated state”, and is taken to be representative of a high probability sequence/structure combination.

To determine the fitness of each amino acid/rotamer at a specific position in the context of the nucleated state, the side chain identities and rotamers at all other positions in the protein are frozen. The rotamers of all amino acid types are then sampled exhaustively (drawing from a rotamer library) at step 56 for the position of interest, and the energy of the corresponding model is evaluated according to the scoring function(s). The Boltzmann weight of each sampled side chain/rotamer is then added to an ongoing partition function as follows:

$${Q}_{x , r , i} = {\sum }_{m = 1}^{N} {\sum }_{s} {ⅇ}^{- Δ {E}_{x , r , s , i , m} / RT}$$

Where x is the amino acid type, s is a sub-rotamer state of rotamer r of amino acid x, i is the position in the structure, m is the nucleated model, and N is the total number of models used. E_{x,r,s,i,m} is the total calculated energy, according to the scoring function described above, of the nucleated model, given the current sub-rotamer of amino acid type x at position i. In a preferred embodiment, 15 sub-rotamer states within 20 degrees of the central rotamer state are sampled randomly. A set of partition functions {Q_{x,r,i}} for all amino acid rotamers at all positions in the protein defines a probability matrix.

The partition function for each amino acid/rotamer combination is continually updated at step 60 as more backbone structures and/or nucleated states are added to the simulation via the cycle between steps 52 and 58. Because each nucleated state contains a unique configuration of backbone structure, side chain identities, and rotamers, each rotamer state is exposed to a wide range of environments; again, this allows a greater sampling of sequence space.

In a preferred embodiment, the application of the cycles would involve the selection of a new backbone structure for each cycle. It is generally found that the use of at least 30 cycles between steps 52 and 58 is sufficient to ensure statistical convergence, although in some cases fewer cycles will suffice, and in some cases more cycles are used. There is also generally a practical upper limit on the number of cycles that is dependent on time limitations imposed by the CPU 22 of the computer.

The total partition function Q_{x,r,i} for amino acid type x, in rotamer state r, at position i, evaluated over N model structures, can be converted to a Helmholtz free energy at step 62 using the equation below:

A_{x,r,i}=−RTlnQ_{x,r,i}

where A_{x,r,i} is the Helmholtz free energy of amino acid x in rotamer state r at position i. The temperature (T) in both equations can have a range of values and should be optimized for the application. Values ranging from 300 K to 3000 K have been used successfully.

In a preferred embodiment, at least two cycles between steps 50 and 60 are performed to ensure self-consistency in the final probability matrix and free energy values. In a preferred embodiment, the Q_{x,r,i} values, representing the cumulative probability of each rotamer state, are used to guide the next cycle of design simulations by serving as a probabilistic selection matrix for amino acids and rotamers in step 54.

In an alternative embodiment, the partition functions for all rotamers of each amino acid at each position are added together to represent the total probability of the amino acid x at position i:

$${Q}_{x , i} = {\sum }_{r} {Q}_{x , r , i}$$

In such cases, the Helmholtz free energy for each amino acid at each position is calculated as:

A_{x,i}=−RTlnQ_{x,i}+T_{—}Sₓ

where _Sₓ represents an estimate of the configurational entropy of amino acid type x in an appropriate reference state.

In a preferred embodiment, the probability matrix defined by the set {Q_{x,r,i}} or the free energy matrix defined by the set {A_{x,r,i}} is utilized to design a single optimal protein sequence for the structure as in step 64 of FIG. 2. It should be noted that while a single solution may be reached, it is also possible to choose as the “optimized” protein a solution close to the global solution.

As outlined below, the protein sequence can be physically produced in the laboratory by well known methods and characterized.

In an alternative preferred embodiment, the probability matrix or free energy matrix is utilized to guide the design of one or more combinatorial libraries of protein sequences, as in step 66 of FIG. 2. A combinatorial library is taken herein to mean a large set of protein sequences wherein each individual sequence is made up of some combination of amino acids as specified by construction of the library.

Because of the importance of combinatorial libraries to the general goal of producing proteins with altered or improved properties, the quality and nature of the probability or free energy matrix that is used to design the combinatorial libraries is of immense importance. The present invention produces a probability matrix that is superior in several aspects to matrices that can be derived by application of a typical protein design algorithm. A typical protein design algorithm can be encouraged to generate a crude probability matrix based on repeated application of the algorithm under different conditions (different backbones, different random number seeds, etc.), as in a cycle between steps 52 and 54 of FIG. 2. However, such a matrix will in most cases contain incomplete information: if an amino acid is never found at a particular position, the user does not know if the amino acid is not found because it is unfavorable, or if it simply has not occurred in a set number of repeated applications. Furthermore, the quantitative accuracy of the probability matrix derived in such a manner can be compromised by similar circumstances.

In contrast to these limitations, the present invention provides a quantitatively superior probability matrix. All amino acids are evaluated at every cycle of the program (step 56 of FIG. 2), within multiple contexts.

In certain circumstances, it may be desirable to predict the viable sequence space for a protein that is subject to multiple constraints. For example, some proteins function by adopting two distinct structural forms. Each form would give rise to its own probability matrix. In such cases, application of the present invention can be used to combine information from separate probability matrices such that a single probability matrix is defined that incorporates multiple constraints. In a preferred embodiment, the information is combined by adding or subtracting free A energy matrices derived from the probability matrices. Furthermore, in a preferred embodiment, the combining process is applied iteratively to ensure proper convergence to a unified solution.

### Parameterization of Scoring Functions and Simulation Variables

A central aspect of protein design algorithms is the choice of appropriate parameters for use in the energy/scoring function that determines the quality of a designed model. The present invention provides an approach for parameterizing protein design algorithms that incorporates statistical information from natural protein families. This approach represents an important departure from other methods that use limited experimental information to optimize parameters: because natural protein sequences are selected under multiple evolutionary constraints, the use of natural sequence statistics provides a comprehensive measure of the quality of a designed protein sequence, and by extension, a better measure of a parameter optimum.

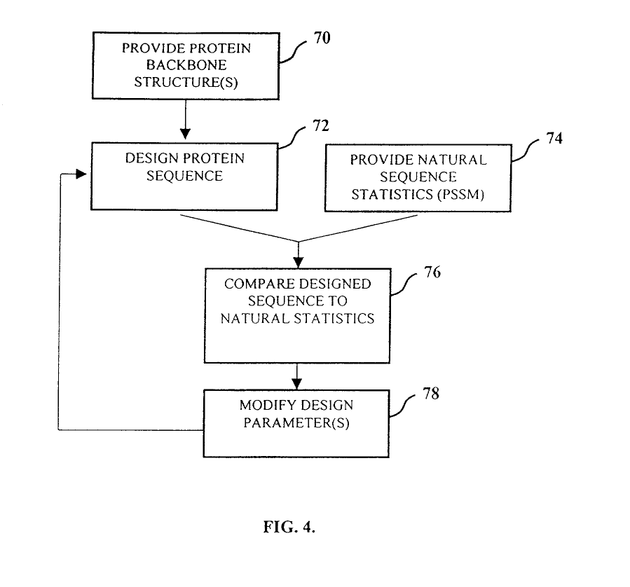

The current invention utilizes natural protein sequence statistics, in the form of position-specific scoring matrices, to quantitatively evaluate and optimize parameters for one or more scoring functions. The method is also extremely useful for determining optimal parameters for other aspects of protein design simulations, such as the extent of diversity in side chain placement (rotamer orientations) or the extent of diversity in backbone structure when using an ensemble-based protein design method. The method can be appreciated more fully by reference to FIG. 4.

To apply the parameter optimization procedure, a natural protein structure 70, to be used as a training system, is chosen, for example from the protein data bank (PDB). In a preferred embodiment, the protein is a member of a large and diverse family of proteins with related structures (for instance, SH3 domains, RRM domains, _-_-_domains _-barrel domains, SH2 domains, leucine zipper domains, zinc finger kinase domains, etc.). Application of a protein design algorithm yields a designed protein sequence at step 72 of FIG. 4. The properties of the designed sequence are compared to natural protein statistics 74.

In a preferred embodiment, a multiple sequence alignment for the protein family is constructed using any of a number of available programs, including but not limited to ClustalW, HMMER, BLASTX and the like. Alternatively, a pre-existing alignment of the family is downloaded from a repository such as the Pfam database (http:Hlpfam.wustl.edu/index.html). There are a number of secondary structure prediction methods, including, but not limited to, threading (Bryant and Altschul, Curr Opin Struct Biol 5(2):236-244. (1995)), Profile 3D (Bowie, et al., Methods Enzymol 266(598-616 (1996); MONSSTER (Skolnick, et al., J Mol Biol 265(2):217-241. (1997); Rosetta (Simons, et al., Proteins 37(S3):171-176 (1999); PSI-BLAST (Altschul and Koonin, Trends Biochem Sci 23(11):444-447. (1998)); Impala (Schaffer, et al., Bioinformatics 15(12):1000-1011. (1999)); HMMER (McClure, et al., Proc Int Conf Intell Syst Mol Biol 4(155-164 (1996)); Clustal W (http://www.ebi.ac.uk/clustalw/); BLAST (Altschul, et al., J Mol Biol 215(3):403-410. (1990)), helix-coil transition theory (Munoz and Serrano, Biopolymers 41:495,1997), neural networks, local structure alignment and others (e.g., see in Selbig et al., Bioinformatics 15:1039, 1999).

In a preferred embodiment, a position-specific scoring matrix (PSSM) made up of numerical elements {M_{x,l}}, where x is the amino acid type and i is the position in the alignment, is determined from the multiple sequence alignment. As will be appreciated by those in the art, this matrix is used to encode the average suitability of each amino acid type at each position of the structure by reporting the trends that were followed by nature. A total figure of merit F (often referred to as a profile score) for a designed sequence is taken as the sum of the M_{x,i} values over the complete sequence {xᵢ, i=1,N} of length N:

$$F = {\sum }_{i = 1}^{N} {M}_{x , i}$$

In its simplest embodiment, the matrix will encode the frequencies {f_{x,i}} or log frequencies {log(f_{x,i})} with which each of the twenty amino acid types occurs at each position in the alignment.

M_{x,i}=log ƒ_{x,i}

In a preferred embodiment, the PSSM is composed of the log-odds ratios for each of the amino acid types at each position. This ratio is defined as the log of the ratio of the position-specific frequency f_{x,i}, of each amino acid type at position i in the alignment, and its overall frequency of occurrence in all proteins qₓ.

$${M}_{x , i} = log ( \frac{{f}_{x , i}}{{q}_{x}} )$$

Note that if f_{x,i}=0, then f_{x,i} is artificially set to a small positive constant (such as 0.001) to avoid issues with the log factor. In a preferred embodiment, sequence-weighting procedures (Henikoff & Henikoff, 1994) are used to adjust the frequencies in the alignment to more accurately represent the diversity of the family.

A protein design algorithm is applied to generate an optimal or near-optimal sequence or set of sequences for the target (training) protein, using a starting set of parameters. The parameter to be optimized is systematically varied at step 78 of FIG. 4. For each new value of the parameter, a new designed sequence is generated at step 72, and evaluated by the function F at step 76. The optimal value of the parameter is thus estimated as that which yields the optimal value of F. In an alternative procedure, several parameters are simultaneously optimized by a steepest descents or conjugate gradient procedure. In this procedure, all parameters will be adjusted simultaneously in the direction of maximal increase in the F score, determined numerically by small perturbations of each individual parameter. Finally, in order to ensure generality of the parameters, a number of training proteins (and families) are used to derive parameters that yield the best average set of parameters for the algorithm.

For design simulations such as mean field methods, ensemble-based calculations, or methods that estimate amino acid probabilities by monte carlo methods, the parameterization method can also be applied. In such cases, the figure of merit will be a weighted average of the log-odds scores according to the ensemble probabilities. If {p_{x,i}} represents a matrix of amino acid probabilities calculated from the simulation(s), then the ensemble averaged figure of merit is given by:

$$⟨ F ⟩ = {\sum }_{i = 1}^{N} {\sum }_{x = 1}^{20} {p}_{x , i} log ( \frac{{f}_{x , i}}{{q}_{x , i}} )$$

Estimation of Amino Acid Reference Energies. A key set of parameters for protein design are terms that represents the intrinsic energetic cost of placing a given amino acid type at any position in the protein, regardless of the environment. These terms have also been referred to as “baseline corrections”. The present invention provides a method for derivation of a set of twenty reference values using natural sequence information. The resulting values are general, in the sense that they can be applied to a variety of protein motifs.

A set {Eₓ} of 20 amino acid reference energies can be added to a protein design scoring function directly as the summation:

$$CC = {\sum }_{x = 1}^{20} {NC}_{x , d} {E}_{x}$$

where C_{x,d} is the fractional composition of amino acid type x in the designed sequence and N is the length of the sequence. Derivation of amino acid reference energies is based on the assumption that the optimal set of values is that which, when included in the scoring function of a protein design algorithm, yields the most correct designed compositions for a set of target backbone structures. The definition of correct can have several meanings, as discussed below.

Assuming that the “correct” target composition {C_{x,t}} is predefined, reference values are iteratively optimized by comparing the compositions of designed sequences to target sequences. First, a protein design algorithm is applied to generate an optimal or near-optimal sequence for a target (training) protein, using a starting set of reference energies (typically zero for the first round of iteration). Next, the composition of the designed sequence {C_{x,d}} is calculated from the final output of the simulation and quantitatively compared to the target composition {C_{x,t}} to yield a correction factor for each reference energy.

$${correction}_{x} = b log ( \frac{{C}_{x , d}}{{C}_{x , t}} )$$

where b is a parameter that determines the rate of training. The correction factor derived for a given round of iteration is added to the previous value of the reference energy to yield an updated value of the reference energy,

$${E}_{x , k} = {E}_{x , k - 1} + b log ( \frac{{C}_{x , d}}{{C}_{x , t}} )$$

where E_{x,k} is the value of the reference energy Eₓ for the kth round of training. The mechanism of the correction factor should be clear: if the design algorithm incorporates an excessive amount of amino acid type x, the reference energy Eₓ for that amino acid is increased incrementally.

Because of the log factor in the correction term, a few special conditions are required for cases in which either C_{x,d} or C_{x,t} is zero. (a) If C_{x,d}=0, then a simple constant correction term (e.g. −0.1 kcal/mol) is applied to favor the incorporation of amino acid type x in designed sequences. (b) If C_{x,t}=0, C_{x,t} is artificially set equal to 0.01 (or some other small factor). in a preferred embodiment, a condition is set so that if the C_{x,d} and C_{x,t} differ by a preset small amount, no correction is made.

This ensures stable convergence to a final set of reference energies The preceding steps are repeated until a converged set of parameters are defined. In a preferred embodiment, the whole procedure is repeated for a number of training proteins. This is done to ensure that the final reference energy values are robust and generally applicable. The average values of the reference energies derived from all training proteins serve as the final values. In an alternative embodiment, separate values of reference energies are derived for different classes of structure by clustering the proteins according to commonalities such as secondary structural class.

Several definitions of a correct target composition are possible. In a preferred embodiment, the target composition is equal to the composition of the single native sequence of the protein from which the training structure was derived.

Once the variant protein sequence(s) are generated, there are a wide variety of experimental methods of synthesizing the actual sequence(s).

In a preferred embodiment, the different variant proteins may be chemically synthesized. This is particularly useful when the designed proteins are short, preferably less than 150 amino acids in length, with less than 100 amino acids being preferred, and less than 50 amino acids being particularly preferred, although as is known in the art, longer proteins can be made chemically or enzymatically. See for example Wilken et al, Curr. Opin. Biotechnol. 9:412-26 (1998), hereby expressly incorporated by reference.

In a preferred embodiment, particularly for longer proteins or proteins for which large samples are desired, the variant sequences are used to create nucleic acids such as DNA which encode the member sequences and which can then be cloned into host cells, expressed and assayed, if desired. Thus, nucleic acids, and particularly DNA, can be made which encodes each member protein sequence. This is done using well known procedures. The choice of codons, suitable expression vectors and suitable host cells will vary depending on a number of factors, and can be easily optimized as needed.

There are a wide variety of experimental techniques that can be used to experimentally generate either the single model proteins or the libraries of proteins of the invention, including, but not limited to, Rachitt-Enchira (http://www.enchira.com/gene_shuffling.htm); error-prone PCR, for example using modified nucleotides; known mutagenesis techniques including the use of multi-cassettes; DNA shuffling (Crameri, et al., Nature 391 (6664):288-291. (1998)); heterogeneous DNA samples (US5939250); ITCHY (Ostermeier, et al., Nat Biotechnol 17(12):1205-1209. (1999)); StEP (Zhao, et al., Nat Biotechnol 16(3):258-261. (1998)), GSSM (U.S. Pat. Nos. 6,171,820, 5,965,408); in vivo homologous recombination, ligase assisted gene assembly, end-complementary PCR, profusion (Roberts and Szostak, Proc Natl Acad Sci U S A 94(23):12297-12302. (1997)); yeast/bacteria surface display (Lu, et al., Biotechnology (N Y) 13(4):366-372. (1995);Seed and Aruffo, Proc Natl Acad Sci U S A 84(10):3365-3369. (1987);Boder and Wittrup, Nat Biotechnol 15(6):553-557. (1997)).

Using the nucleic acids of the present invention which encode a single designed protein or library members, a variety of expression vectors are made. The expression vectors may be either self-replicating extrachromosomal vectors or vectors which integrate into a host genome. Generally, these expression vectors include transcriptional and translational regulatory nucleic acid operably linked to the nucleic acid encoding the designed protein(s). The term “control sequences” refers to DNA sequences necessary for the expression of an operably linked coding sequence in a particular host organism. The control sequences that are suitable for prokaryotes, for example, include a promoter, optionally an operator sequence, and a ribosome binding site. Eukaryotic cells are known to utilize promoters, polyadenylation signals, and enhancers.

Nucleic acid is “operably linked” when it is placed into a functional relationship with another nucleic acid sequence. For example, DNA for a presequence or secretory leader is operably linked to DNA for a polypeptide if it is expressed as a preprotein that participates in the secretion of the polypeptide; a promoter or enhancer is operably linked to a coding sequence if it affects the transcription of the sequence; or a ribosome binding site is operably linked to a coding sequence if it is positioned so as to facilitate translation. Generally, “operably linked” means that the DNA sequences being linked are contiguous, and, in the case of a secretory leader, contiguous and in reading phase. However, enhancers do not have to be contiguous. Linking is accomplished by ligation at convenient restriction sites. If such sites do not exist, the synthetic oligonucleotide adaptors or linkers are used in accordance with conventional practice. The transcriptional and translational regulatory nucleic acid will generally be appropriate to the host cell used to express the library protein, as will be appreciated by those in the art; for example, transcriptional and translational regulatory nucleic acid sequences from Bacillus are preferably used to express the library protein in Bacillus. Numerous types of appropriate expression vectors, and suitable regulatory sequences are known in the art for a variety of host cells.

In general, the transcriptional and translational regulatory sequences may include, but are not limited to, promoter sequences, ribosomal binding sites, transcriptional start and stop sequences, translational start and stop sequences, and enhancer or activator sequences. In a preferred embodiment, the regulatory sequences include a promoter and transcriptional start and stop sequences. Promoter sequences include constitutive and inducible promoter sequences. The promoters may be either naturally occurring promoters, hybrid or synthetic promoters. Hybrid promoters, which combine elements of more than one promoter, are also known in the art, and are useful in the present invention.

In addition, the expression vector may comprise additional elements. For example, the expression vector may have two replication systems, thus allowing it to be maintained in two organisms, for example in mammalian or insect cells for expression and in a prokaryotic host for cloning and amplification. Furthermore, for integrating expression vectors, the expression vector contains at least one sequence homologous to the host cell genome, and preferably two homologous sequences which flank the expression construct. The integrating vector may be directed to a specific locus in the host cell by selecting the appropriate homologous sequence for inclusion in the vector. Constructs for integrating vectors and appropriate selection and screening protocols are well known in the art and are described in e.g., Mansour et al., Cell, 51:503 (1988) and Murray, Gene Transfer and Expression Protocols, Methods in Molecular Biology, Vol. 7 (Clifton: Humana Press, 1991).

In addition, in a preferred embodiment, the expression vector contains a selection gene to allow the selection of transformed host cells containing the expression vector, and particularly in the case of mammalian cells, ensures the stability of the vector, since cells which do not contain the vector will generally die. Selection genes are well known in the art and will vary with the host cell used. By “selection gene” herein is meant any gene which encodes a gene product that confers resistance to a selection agent. Suitable selection agents include, but are not limited to, neomycin (or its analog G418), blasticidin S, histinidol D, bleomycin, puromycin, hygromycin B, and other drugs.

In a preferred embodiment, the expression vector contains a RNA splicing sequence upstream or downstream of the gene to be expressed in order to increase the level of gene expression. See Barret et al., Nucleic Acids Res. 1991; Groos et al., Mol. Cell. Biol. 1987; and Budiman et al., Mol. Cell. Biol. 1988.

A preferred expression vector system is a retroviral vector system such as is generally described in Mann et al., Cell, 33:153-9 (1993); Pear et al., Proc. Natl. Acad. Sci. U.S.A., 90(18):8392-6 (1993); Kitamura et al., Proc. Natl. Acad. Sci. U.S.A., 92:9146-50 (1995); Kinsella et al., Human Gene Therapy, 7:1405-13; Hofmann et al., Proc. Natl. Acad. Sci. U.S.A., 93:5185-90; Choate et al., Human Gene Therapy, 7:2247 (1996); PCT/US97/01019 and PCT/US97/01048, and references cited therein, all of which are hereby expressly incorporated by reference.

The designed proteins of the present invention are produced by culturing a host cell transformed with nucleic acid, preferably an expression vector, containing nucleic acid encoding a designed protein, under the appropriate conditions to induce or cause expression of the designed protein. The conditions appropriate for protein expression will vary with the choice of the expression vector and the host cell, and will be easily ascertained by one skilled in the art through routine experimentation. For example, the use of constitutive promoters in the expression vector will require optimizing the growth and proliferation of the host cell, while the use of an inducible promoter requires the appropriate growth conditions for induction. In addition, in some embodiments, the timing of the harvest is important. For example, the baculoviral systems used in insect cell expression are lytic viruses, and thus harvest time selection can be crucial for product yield.

As will be appreciated by those in the art, the type of cells used in the present invention can vary widely. Basically, a wide variety of appropriate host cells can be used, including yeast, bacteria, archaebacteria, fungi, and insect and animal cells, including mammalian cells. Of particular interest are Drosophila melanogaster cells, Saccharomyces cerevisiae and other yeasts, E. coli, Bacillus subtilis, SF9 cells, C129 cells, 293 cells, Neurospora, BHK, CHO, COS, and HeLa cells, fibroblasts, Schwanoma cell lines, immortalized mammalian myeloid and lymphoid cell lines, Jurkat cells, mast cells and other endocrine and exocrine cells, and neuronal cells. See the ATCC cell line catalog, hereby expressly incorporated by reference. In addition, the expression of the libraries in phage display systems, such as are well known in the art, are particularly preferred, especially when the library comprises random peptides. In one embodiment, the cells may be genetically engineered, that is, contain exogeneous nucleic acid, for example, to contain target molecules.

In a preferred embodiment, the designed proteins are expressed in mammalian cells. Any mammalian cells may be used, with mouse, rat, primate and human cells being particularly preferred, although as will be appreciated by those in the art, modifications of the system by pseudotyping allows all eukaryotic cells to be used, preferably higher eukaryotes. As is more fully described below, a screen will be set up such that the cells exhibit a selectable phenotype in the presence of a random library member. As is more fully described below, cell types implicated in a wide variety of disease conditions are particularly useful, so long as a suitable screen may be designed to allow the selection of cells that exhibit an altered phenotype as a consequence of the presence of a library member within the cell.

Accordingly, suitable mammalian cell types include, but are not limited to, tumor cells of all types (particularly melanoma, myeloid leukemia, carcinomas of the lung, breast, ovaries, colon, kidney, prostate, pancreas and testes), cardiomyocytes, endothelial cells, epithelial cells, lymphocytes (T-cell and B cell) , mast cells, eosinophils, vascular intimal cells, hepatocytes, leukocytes including mononuclear leukocytes, stem cells such as haemopoetic, neural, skin, lung, kidney, liver and myocyte stem cells (for use in screening for differentiation and de-differentiation factors), osteoclasts, chondrocytes and other connective tissue cells, keratinocytes, melanocytes, liver cells, kidney cells, and adipocytes. Suitable cells also include known research cells, including, but not limited to, Jurkat T cells, NIH3T3 cells, CHO, Cos, etc. See the ATCC cell line catalog, hereby expressly incorporated by reference.

Mammalian expression systems are also known in the art, and include retroviral systems. A mammalian promoter is any DNA sequence capable of binding mammalian RNA polymerase and initiating the downstream (3′) transcription of a coding sequence for a designed protein into mRNA. A promoter will have a transcription initiating region, which is usually placed proximal to the 5′ end of the coding sequence, and a TATA box, using a located 25-30 base pairs upstream of the transcription initiation site. The TATA box is thought to direct RNA polymerase II to begin RNA synthesis at the correct site. A mammalian promoter will also contain an upstream promoter element (enhancer element), typically located within 100 to 200 base pairs upstream of the TATA box. An upstream promoter element determines the rate at which transcription is initiated and can act in either orientation. Of particular use as mammalian promoters are the promoters from mammalian viral genes, since the viral genes are often highly expressed and have a broad host range. Examples include the SV40 early promoter, mouse mammary tumor virus LTR promoter, adenovirus major late promoter, herpes simplex virus promoter, and the CMV promoter.

Typically, transcription termination and polyadenylation sequences recognized by mammalian cells are regulatory regions located 3′ to the translation stop codon and thus, together with the promoter elements, flank the coding sequence. The 3′ terminus of the mature mRNA is formed by site-specific post-translational cleavage and polyadenylation. Examples of transcription terminator and polyadenlytion signals include those derived form SV40.

The methods of introducing exogenous nucleic acid into mammalian hosts, as well as other hosts, is well known in the art, and will vary with the host cell used. Techniques include dextran-mediated transfection, calcium phosphate precipitation, polybrene mediated transfection, protoplast fusion, electroporation, viral infection, encapsulation of the polynucleotide(s) in liposomes, and direct microinjection of the DNA into nuclei.

In a preferred embodiment, designed library proteins are expressed in bacterial systems. Bacterial expression systems are well known in the art.

A suitable bacterial promoter is any nucleic acid sequence capable of binding bacterial RNA polymerase and initiating the downstream (3′) transcription of the coding sequence of library protein into mRNA. A bacterial promoter has a transcription initiation region which is usually placed proximal to the 5′ end of the coding sequence. This transcription initiation region typically includes an RNA polymerase binding site and a transcription initiation site. Sequences encoding metabolic pathway enzymes provide particularly useful promoter sequences. Examples include promoter sequences derived from sugar metabolizing enzymes, such as galactose, lactose and maltose, and sequences derived from biosynthetic enzymes such as tryptophan. Promoters from bacteriophage may also be used and are known in the art. In addition, synthetic promoters and hybrid promoters are also useful; for example, the tac promoter is a hybrid of the trp and lac promoter sequences. Furthermore, a bacterial promoter can include naturally occurring promoters of non-bacterial origin that have the ability to bind bacterial RNA polymerase and initiate transcription.

In addition to a functioning promoter sequence, an efficient ribosome binding site is desirable. In E. coli, the ribosome binding site is called the Shine-Delgarno (SD) sequence and includes an initiation codon and a sequence 3-9 nucleotides in length located 3-11 nucleotides upstream of the initiation codon.

The expression vector may also include a signal peptide sequence that provides for secretion of the designed protein in bacteria. The signal sequence typically encodes a signal peptide comprised of hydrophobic amino acids which direct the secretion of the protein from the cell, as is well known in the art. The protein is either secreted into the growth media (gram-positive bacteria) or into the periplasmic space, located between the inner and outer membrane of the cell (gram-negative bacteria).

The bacterial expression vector may also include a selectable marker gene to allow for the selection of bacterial strains that have been transformed. Suitable selection genes include genes which render the bacteria resistant to drugs such as ampicillin, chloramphenicol, erythromycin, kanamycin, neomycin and tetracycline. Selectable markers also include biosynthetic genes, such as those in the histidine, tryptophan and leucine biosynthetic pathways.

These components are assembled into expression vectors. Expression vectors for bacteria are well known in the art, and include vectors for Bacillus subtilis, E. coli, Streptococcus cremoris, and Streptococcus lividans, among others.

The bacterial expression vectors are transformed into bacterial host cells using techniques well known in the art, such as calcium chloride treatment, electroporation, and others.

In one embodiment, the designed proteins are produced in insect cells. Expression vectors for the transformation of insect cells, and in particular, baculovirus-based expression vectors, are well known in the art and are described e.g., in O'Reilly et al., Baculovirus Expression Vectors: A Laboratory Manual (New York: Oxford University Press, 1994).

In a preferred embodiment, modeled protein is produced in yeast cells. Yeast expression systems are well known in the art, and include expression vectors for Saccharomyces cerevisiae, Candida albicans and C. maltosa, Hansenula polymorpha, Kluyveromyces fragilis and K. lactis, Pichia guillerimondii and P. pastoris, Schizosaccharomyces pombe, and Yarrowia lipolytica. Preferred promoter sequences for expression in yeast include the inducible GAL1,10 promoter, the promoters from alcohol dehydrogenase, enolase, glucokinase, glucose-6-phosphate isomerase, glyceraldehyde-3-phosphate-dehydrogenase, hexokinase, phosphofructokinase, 3-phosphoglycerate mutase, pyruvate kinase, and the acid phosphatase gene. Yeast selectable markers include ADE2, HIS4, LEU2, TRP1, and ALG7, which confers resistance to tunicamycin; the neomycin phosphotransferase gene, which confers resistance to G418; and the CUP1 gene, which allows yeast to grow in the presence of copper ions.

The modeled protein may also be made as a fusion protein, using techniques well known in the art. Thus, for example, for the creation of monoclonal antibodies, if the desired epitope is small, the designed protein may be fused to a carrier protein to form an immunogen. Alternatively, the designed protein may be made as a fusion protein to increase expression, or for other reasons. For example, when the library protein is an library peptide, the nucleic acid encoding the peptide may be linked to other nucleic acid for expression purposes. Similarly, other fusion partners may be used, such as targeting sequences which allow the localization of the library members into a subcellular or extracellular compartment of the cell, rescue sequences or purification tags which allow the purification or isolation of either the library protein or the nucleic acids encoding them; stability sequences, which confer stability or protection from degradation to the library protein or the nucleic acid encoding it, for example resistance to proteolytic degradation, or combinations of these, as well as linker sequences as needed.

Thus, suitable targeting sequences include, but are not limited to, binding sequences capable of causing binding of the expression product to a predetermined molecule or class of molecules while retaining bioactivity of the expression product, (for example by using enzyme inhibitor or substrate sequences to target a class of relevant enzymes); sequences signalling selective degradation, of itself or co-bound proteins; and signal sequences capable of constitutively localizing the candidate expression products to a predetermined cellular locale, including a) subcellular locations such as the Golgi, endoplasmic reticulum, nucleus, nucleoli, nuclear membrane, mitochondria, chloroplast, secretory vesicles, lysosome, and cellular membrane; and b) extracellular locations via a secretory signal. Particularly preferred is localization to either subcellular locations or to the outside of the cell via secretion.

In a preferred embodiment, the library member comprises a rescue sequence. A rescue sequence is a sequence which may be used to purify or isolate either the candidate agent or the nucleic acid encoding it. Thus, for example, peptide rescue sequences include purification sequences such as the His₆ tag for use with Ni affinity columns and epitope tags for detection, immunoprecipitation or FACS (fluoroscence-activated cell sorting). Suitable epitope tags include myc (for use with the commercially available 9E10 antibody), the BSP biotinylation target sequence of the bacterial enzyme BirA, flu tags, lacZ, and GST. Alternatively, the rescue sequence may be a unique oligonucleotide sequence which serves as a probe target site to allow the quick and easy isolation of the retroviral construct, via PCR, related techniques, or hybridization.

In a preferred embodiment, the fusion partner is a stability sequence to confer stability to the library member or the nucleic acid encoding it. Thus, for example, peptides may be stabilized by the incorporation of glycines after the initiation methionine (MG or MGGO), for protection of the peptide to ubiquitination as per Varshavsky's N-End Rule, thus conferring long half-life in the cytoplasm. Similarly, two prolines at the C-terminus impart peptides that are largely resistant to carboxypeptidase action. The presence of two glycines prior to the prolines impart both flexibility and prevent structure initiating events in the di-proline to be propagated into the candidate peptide structure. Thus, preferred stability sequences are as follows: MG(X)nGGPP, where X is any amino acid and n is an integer of at least four.

In one embodiment, any of the designed nucleic acids, proteins and antibodies of the invention are labeled. By “labeled” herein is meant that nucleic acids, proteins and antibodies of the invention have at least one element, isotope or chemical compound attached to enable the detection of nucleic acids, proteins and antibodies of the invention. In general, labels fall into three classes: a) isotopic labels, which may be radioactive or heavy isotopes; b) immune labels, which may be antibodies or antigens; and c) colored or fluorescent dyes. The labels may be incorporated into the compound at any position.

In a preferred embodiment, the modeled protein is purified or isolated after expression. Designed proteins may be isolated or purified in a variety of ways known to those skilled in the art depending on what other components are present in the sample. Standard purification methods include electrophoretic, molecular, immunological and chromatographic techniques, including ion exchange, hydrophobic, affinity, and reverse-phase HPLC chromatography, and chromatofocusing. For example, the library protein may be purified using a standard anti-library antibody column. Ultrafiltration and diafiltration techniques, in conjunction with protein concentration, are also useful. For general guidance in suitable purification techniques, see Scopes, R., Protein Purification, Springer-Verlag, NY (1982). The degree of purification necessary will vary depending on the use of the library protein. In some instances no purification will be necessary.

Once expressed and purified if necessary, the library proteins and nucleic acids are useful in a number of applications.

In general, the libraries are screened for biological activity. These screens will be based on the scaffold protein chosen, as is known in the art. Thus, any number of protein activities or attributes may be tested, including its binding to its known binding members (for example, its substrates, if it is an enzyme), activity profiles, stability profiles (pH, thermal, buffer conditions), substrate specificity, immunogenicity, toxicity, etc.

When random peptides are made, these may be used in a variety of ways to screen for activity. In a preferred embodiment, a first plurality of cells is screened. That is, the cells into which the library member nucleic acids are introduced are screened for an altered phenotype. Thus, in this embodiment, the effect of the library member is seen in the same cells in which it is made; i.e. an autocrine effect.

By a “plurality of cells” herein is meant roughly from about 10³ cells to 10⁸ or 10⁹, with from 10⁶ to 10⁸ being preferred. This plurality of cells comprises a cellular library, wherein generally each cell within the library contains a member of the designed library, i.e. a different library member, although as will be appreciated by those in the art, some cells within the library may not contain one and and some may contain more than one. When methods other than retroviral infection are used to introduce the library members into a plurality of cells, the distribution of library members within the individual cell members of the cellular library may vary widely, as it is generally difficult to control the number of nucleic acids which enter a cell during electroporation, etc.

In a preferred embodiment, the library nucleic acids are introduced into a first plurality of cells, and the effect of the library members is screened in a second or third plurality of cells, different from the first plurality of cells, i.e. generally a different cell type. That is, the effect of the library member is due to an extracellular effect on a second cell; i.e. an endocrine or paracrine effect. This is done using standard techniques. The first plurality of cells may be grown in or on one media, and the media is allowed to touch a second plurality of cells, and the effect measured. Alternatively, there may be direct contact between the cells. Thus, “contacting” is functional contact, and includes both direct and indirect. In this embodiment, the first plurality of cells may or may not be screened.

If necessary, the cells are treated to conditions suitable for the expression of the library members (for example, when inducible promoters are used), to produce the library proteins.

Thus, in one embodiment, the methods of the present invention comprise introducing a molecular library of library members into a plurality of cells, a cellular library. The plurality of cells is then screened, as is more fully outlined below, for a cell exhibiting an altered phenotype. The altered phenotype is due to the presence of a library member.

By “altered phenotype” or “changed physiology” or other grammatical equivalents herein is meant that the phenotype of the cell is altered in some way, preferably in some detectable and/or measurable way. As will be appreciated in the art, a strength of the present invention is the wide variety of cell types and potential phenotypic changes which may be tested using the present methods. Accordingly, any phenotypic change which may be observed, detected, or measured may be the basis of the screening methods herein. Suitable phenotypic changes include, but are not limited to: gross physical changes such as changes in cell morphology, cell growth, cell viability, adhesion to substrates or other cells, and cellular density; changes in the expression of one or more RNAs, proteins, lipids, hormones, cytokines, or other molecules; changes in the equilibrium state (i.e. half-life) or one or more RNAs, proteins, lipids, hormones, cytokines, or other molecules; changes in the localization of one or more RNAs, proteins, lipids, hormones, cytokines, or other molecules; changes in the bioactivity or specific activity of one or more RNAs, proteins, lipids, hormones, cytokines, receptors, or other molecules; changes in phosphorylation; changes in the secretion of ions, cytokines, hormones, growth factors, or other molecules; alterations in cellular membrane potentials, polarization, integrity or transport; changes in infectivity, susceptability, latency, adhesion, and uptake of viruses and bacterial pathogens; etc. By “capable of altering the phenotype” herein is meant that the library member can change the phenotype of the cell in some detectable and/or measurable way.

The altered phenotype may be detected in a wide variety of ways, and will generally depend and correspond to the phenotype that is being changed. Generally, the changed phenotype is detected using, for example: microscopic analysis of cell morphology; standard cell viability assays, including both increased cell death and increased cell viability, for example, cells that are now resistant to cell death via virus, bacteria, or bacterial or synthetic toxins; standard labeling assays such as fluorometric indicator assays for the presence or level of a particular cell or molecule, including FACS or other dye staining techniques; biochemical detection of the expression of target compounds after killing the cells; etc. In some cases, as is more fully described herein, the altered phenotype is detected in the cell in which the randomized nucleic acid was introduced; in other embodiments, the altered phenotype is detected in a second cell which is responding to some molecular signal from the first cell.

n a preferred embodiment, the library member is isolated from the positive cell. This may be done in a number of ways. In a preferred embodiment, primers complementary to DNA regions common to the constructs, or to specific components of the library such as a rescue sequence, defined above, are used to “rescue” the unique random sequence. Alternatively, the member is isolated using a rescue sequence. Thus, for example, rescue sequences comprising epitope tags or purification sequences may be used to pull out the library member, using immunoprecipitation or affinity columns. In some instances, this may also pull out things to which the library member binds (for example the primary target molecule) if there is a sufficiently strong binding interaction between the library member and the target molecule. Alternatively, the peptide may be detected using mass spectroscopy.

Once rescued, the sequence of the library member is determined. This information can then be used in a number of ways.

In a preferred embodiment, the member is resynthesized and reintroduced into the target cells, to verify the effect. This may be done using retroviruses, or alternatively using fusions to the HIV-1 Tat protein, and analogs and related proteins, which allows very high uptake into target cells. See for example, Fawell et al., PNAS USA 91:664 (1994); Frankel et al., Cell 55:1189 (1988); Savion et al., J. Biol. Chem. 256:1149 (1981); Derossi et al., J. Biol. Chem. 269:10444 (1994); and Baldin et al., EMBO J. 9:1511 (1990), all of which are incorporated by reference.

In a preferred embodiment, the sequence of the member is used to generate more libraries, as outlined herein.

In a preferred embodiment, the library member is used to identify target molecules, i.e. the molecules with which the member interacts. As will be appreciated by those in the art, there may be primary target molecules, to which the library member binds or acts upon directly, and there may be secondary target molecules, which are part of the signalling pathway affected by the library member; these might be termed “validated targets”.

The screening methods of the present invention may be useful to screen a large number of cell types under a wide variety of conditions. Generally, the host cells are cells that are involved in disease states, and they are tested or screened under conditions that normally result in undesirable consequences on the cells. When a suitable library member is found, the undesirable effect may be reduced or eliminated. Alternatively, normally desirable consequences may be reduced or eliminated, with an eye towards elucidating the cellular mechanisms associated with the disease state or signalling pathway.

In a preferred embodiment, the library may be put onto a chip or substrate as an array to make a “protein chip” or “biochip” to be used in high-throughput screening (HTS) techniques. Thus, the invention provides substrates with arrays comprising libraries (generally secondary or tertiary libraries” of proteins.

By “substrate” or “solid support” or other grammatical equivalents herein is meant any material that can be modified to contain discrete individual sites appropriate for the attachment or association of beads and is amenable to at least one detection method. As will be appreciated by those in the art, the number of possible substrates is very large.

Possible substrates include, but are not limited to, glass and modified or functionalized glass, plastics (including acrylics, polystyrene and copolymers of styrene and other materials, polypropylene, polyethylene, polybutylene, polyurethanes, Teflon®, etc.), polysaccharides, nylon or nitrocellulose, resins, silica or silica-based materials including silicon and modified silicon, carbon, metals, inorganic glasses, plastics, optical fiber bundles, and a variety of other polymers. In general, the substrates allow optical detection and do not themselves appreciably fluorescese.

Generally the substrate is flat (planar), although as will be appreciated by those in the art, other configurations of substrates may be used as well; for example, three dimensional configurations can be used. Similarly, the arrays may be placed on the inside surface of a tube, for flow-through sample analysis to minimize sample volume.

By “array” herein is meant a plurality of library members in an array format; the size of the array will depend on the composition and end use of the array. Arrays containing from about 2 different library members to many thousands can be made. Generally, the array will comprise from 10² to 10⁸ different proteins (all numbers are per square centimeter), with from about 10³ to about 10⁶ being preferred and from about 10³ to 10⁵ being particularly preferred. In addition, in some arrays, multiple substrates may be used, either of different or identical compositions. Thus for example, large arrays may comprise a plurality of smaller substrates.

As will be appreciated by those in the art, the library members may either be synthesized directly on the substrate, or they may be made and then attached after synthesis. In a preferred embodiment, linkers are used to attach the proteins to the substrate, to allow both good attachment, sufficient flexibility to allow good interaction with the target molecule, and to avoid undesirable binding reactions.

In a preferred embodiment, the library members are synthesized first, and then covalently or otherwise immobilized to the substrate. This may be done in a variety of ways, including known spotting techniques, ink jet techniques, etc.

As will be appreciated by those in the art, the proteinaceous library members may be attached to the substrate in a wide variety of ways. The functionalization of solid support surfaces such as certain polymers with chemically reactive groups such as thiols, amines, carboxyls, etc. is generally known in the art. Accordingly, substrates may be used that have surface chemistries that facilitate the attachment of the desired functionality by the user. Some examples of these surface chemistries include, but are not limited to, amino groups including aliphatic and aromatic amines, carboxylic acids, aldehydes, amides, chloromethyl groups, hydrazide, hydroxyl groups, sulfonates and sulfates.

These functional groups can be used to add any number of different libraries to the substrates, generally using known chemistries. For example, libraries containing carbohydrates may be attached to an amino-functionalized support; the aldehyde of the carbohydrate is made using standard techniques, and then the aldehyde is reacted with an-amino group on the surface. In an alternative embodiment, a sulfhydryl linker may be used. There are a number of sulfhydryl reactive linkers known n the art such as SPDP, maleimides, a-haloacetyls, and pyridyl disulfides (see for example the 1994 Pierce Chemical Company catalog, technical section on cross-linkers, pages 155-200, incorporated herein by reference) which can be used to attach cysteine containing members to the support. Alternatively, an amino group on the library member may be used for attachment to an amino group on the surface. For example, a large number of stable bifunctional groups are well known in the art, including homobifunctional and heterobifunctional linkers (see Pierce Catalog and Handbook, pages 155-200). In an additional embodiment, carboxyl groups (either from the surface or from the protein) nay be derivatized using well known linkers (see the Pierce catalog). For example, carbodiimides activate carboxyl groups for attack by good nucleophiles such as amines (see Torchilin et al., Critical (Rev. Therapeutic Drug Carrier Systems, 7(4):275-308 (1991), expressly incorporated herein). In addition, library proteins may also be attached using other techniques known in the art, for example for the attachment of antibodies to polymers; see Slinkin et al., Bioconj. Chem. 2:342-348 (1991); Torchilin et al., supra; Trubetskoy et al., Bioconj. Chem. 3:323-327 (1992); King et al., Cancer Res. 54:6176-6185 (1994); and Wilbur et al., Bioconjugate Chem. 5:220-235 (1994), all of which are hereby expressly incorporated by reference). Similarly, when the library members are made recombinantly, the use of epitope tags (FLAG, etc.) or His6 tags allow the attachment of the members to the surface i.e. with antibody coated surfaces, met al (Ni) surfaces, etc.). In addition, labeling the library members with biotin or other binding partner pairs allows the use of avidin coated surfaces, etc. It should be understood that the proteins may be attached in a variety of ways, including those listed above. What is important is that manner of attachment does not significantly alter the functionality of the protein; that is, the protein should be attached in such a flexible manner as to allow its interaction with a target.

Once the biochips are made, they may be used in any number of formats for a wide variety of purposes, as will be appreciated by those in the art. For example, the scaffold protein serving as the library starting point may be an enzyme; by putting libraries of variants on a chip, the variants can be screened for increased activity by adding substrates, or for inhibitors. Similarly, variant libraries of ligand scaffolds can be screened for increased or decreased binding affinity to the binding partner, for example a cell surface receptor. Thus, in this embodiment, for example, the extracellular portion of the receptor can be added to the array and binding affinity tested under any number of conditions; for example, binding and/or activity may be tested under different pH conditions, different buffer, salt or reagent concentrations, different temperatures, in the presence of competitive binders, etc.

Thus, in a preferred embodiment, the methods comprise differential screening to identity bioactive gents that are capable of either binding to the variant proteins and/or modulating the activity of the variant proteins. “Modulation” in this context includes both an increase in activity (e.g. enzymatic activity or binding affinity) and a decrease.

Another preferred embodiment utilizes differential screening to identify drug candidates that bind to the native protein, but cannot bind to modified proteins.

Positive controls and negative controls may be used in the assays. Preferably all control and test samples are performed in at least triplicate to obtain statistically significant results. Incubation of all samples is for a time sufficient for the binding of the agent to the protein. Following incubation, all samples are washed free of non-specifically bound material and the amount of bound, generally labeled agent determined.

A variety of other reagents may be included in the screening assays. These include reagents like salts, neutral proteins, e.g. albumin, detergents, etc which may be used to facilitate optimal protein-protein binding and/or reduce non-specific or background interactions. Also reagents that otherwise improve the efficiency of the assay, such as protease inhibitors, nuclease inhibitors, anti-microbial agents, etc., may be used. The mixture of components may be added in any order that provides for the requisite binding.

In a preferred embodiment, the activity of the variant protein is increased; in another preferred embodiment, the activity of the variant protein is decreased. Thus, bioactive agents that are antagonists are preferred in some embodiments, and bioactive agents that are agonists may be preferred in other embodiments.

Thus, in a preferred embodiment, the biochips comprising the libraries are used to screen candidate agents for binding to library members. By “candidate bioactive agent” or “candidate drugs” or grammatical equivalents herein is meant any molecule, e.g. proteins (which herein includes proteins, polypeptides, and peptides), small organic or inorganic molecules, polysaccharides, polynucleotides, etc. which are to be tested against a particular target. Candidate agents encompass numerous chemical classes. In a preferred embodiment, the candidate agents are organic molecules, particularly small organic molecules, comprising functional groups necessary for structural interaction with proteins, particularly hydrogen bonding, and typically include at least an amine, carbonyl, hydroxyl or carboxyl group, preferably at least two of the functional chemical groups. The candidate agents often comprise cyclical carbon or heterocyclic structures and/or aromatic or polyaromatic structures substituted with one or more chemical functional groups.

Candidate agents are obtained from a wide variety of sources, as will be appreciated by those in the art, including libraries of synthetic or natural compounds. As will be appreciated by those in the art, the present invention provides a rapid and easy method for screening any library of candidate agents, including the wide variety of known combinatorial chemistry-type libraries.

In a preferred embodiment, candidate agents are synthetic compounds. Any number of techniques are available for the random and directed synthesis of a wide variety of organic compounds and biomolecules, including expression of randomized oligonucleotides. See for example WO 94/24314, hereby expressly incorporated by reference, which discusses methods for generating new compounds, including random chemistry methods as well as enzymatic methods. As described in WO 94/24314, one of the advantages of the present method is that it is not necessary to characterize the candidate bioactive agents prior to the assay; only candidate agents that bind to the target need be identified. In addition, as is known in the art, coding tags using split synthesis reactions may be done, to essentially identify the chemical moieties on the beads.

Alternatively, a preferred embodiment utilizes libraries of natural compounds in the form of bacterial, fungal, plant and animal extracts that are available or readily produced, and can be attached to beads as is generally known in the art.

Additionally, natural or synthetically produced libraries and compounds are readily modified through conventional chemical, physical and biochemical means. Known pharmacological agents may be subjected to directed or random chemical modifications, including enzymatic modifications, to produce structural analogs.

In a preferred embodiment, candidate bioactive agents include proteins, nucleic acids, and chemical moieties.

In a preferred embodiment, the candidate bioactive agents are proteins. In a preferred embodiment, the candidate bioactive agents are naturally occurring proteins or fragments of naturally occurring proteins. Thus, for example, cellular extracts containing proteins, or random or directed digests of proteinaceous cellular extracts, may be attached to beads as is more fully described below. In this way libraries of procaryotic and eucaryotic proteins may be made for screening against any number of targets. Particularly preferred in this embodiment are libraries of bacterial, fungal, viral, and mammalian proteins, with the latter being preferred, and human proteins being especially preferred.

In a preferred embodiment, the candidate bioactive agents are peptides of from about 2 to about 50 amino acids, with from about 5 to about 30 amino acids being preferred, and from about 8 to about 20 being particularly preferred. The peptides may be digests of naturally occurring proteins as is outlined above, random peptides, or “biased” random peptides. By “randomized” or grammatical equivalents herein is meant that each nucleic acid and peptide consists of essentially random nucleotides and amino acids, respectively. Since generally these random peptides (or nucleic acids, discussed below) are chemically synthesized, they may incorporate any nucleotide or amino acid at any position. The synthetic process can be designed to generate randomized proteins or nucleic acids, to allow the formation of all or most of the possible combinations over the length of the sequence, thus forming a library of randomized candidate bioactive proteinaceous agents. In addition, the candidate agents may themselves be the product of the invention; that is, a library of proteinaceous candidate agents may be made using the methods of the invention.

The library should provide a sufficiently structurally diverse population of randomized agents to effect a probabilistically sufficient range of diversity to allow binding to a particular target. Accordingly, an interaction library must be large enough so that at least one of its members will have a structure that gives it affinity for the target. Although it is difficult to gauge the required absolute size of an interaction library, nature provides a hint with the immune response: a diversity of 10⁷-10⁸ different antibodies provides at least one combination with sufficient affinity to interact with most potential antigens faced by an organism. Published in vitro selection techniques have also shown that a library size of 10⁷-10⁸ is sufficient to find structures with affinity for the target. A library of all combinations of a peptide 7 to 20 amino acids in length, such as generally proposed herein, has the potential to code for 20⁷ (10⁹) to 20²⁰. Thus, with libraries of 10⁷-10⁸ different molecules the present methods allow a “working” subset of a theoretically complete interaction library for 7 amino acids, and a subset of shapes for the 20²⁰ library. Thus, in a preferred embodiment, at least 10⁶, preferably at least 10⁷, more preferably at least 10⁸ and most preferably at least 10⁹ different sequences are simultaneously analyzed in the subject methods. Preferred methods maximize library size and diversity.

Thus, in a preferred embodiment, the invention provides biochips comprising libraries of variant proteins, with the library comprising at least about 100 different variants, with at least about 500 different variants being preferred, about 1000 different variants being particularly preferred and about 5000-10,000 being especially preferred.

In a preferred embodiment, the candidate bioactive agents are nucleic acids. By “nucleic acid” or “oligonucleotide” or grammatical equivalents herein means at least two nucleotides covalently linked together. A nucleic acid of the present invention will generally contain phosphodiester bonds, although some cases, as outlined below, nucleic acid analogs are included that may have alternate backbones, comprising, for example, phosphoramide (Beaucage et al., Tetrahedron 49(10):1925 1993) and references therein; Letsinger, J. Org. Chem. 35:3800 (1970); Sprinzl et al., Eur. J. Biochem. 81:579 (1977); Letsinger et al., Nucl. Acids Res. 14:3487 (1986); Sawai et al, Chem. Lett. 805 (1984), Letsinger et al., J. Am. Chem. Soc. 110:4470 (1988); and Pauwels et al., Chemica Scripta 26:141 (1986)), phosphorothioate (Mag et al., Nucleic Acids Res. 19:1437 (1991); and U.S. Pat. No. 5,644,048), phosphorodithioate (Briu et al., J. Am. Chem. Soc. 111:2321 (1989), O-methylphophoroamidite linkages (see Eckstein, Oligonucleotides and Analogues: A Practical approach, Oxford University Press), and peptide nucleic acid backbones and linkages (see Egholm, J. Am. Chem. Soc. 114:1895 (1992); Meier et al., Chem. lnt. Ed. Engl. 31:1008 (1992); Nielsen, Nature, 365:566 (1993); Carlsson et al., Nature 380:207 (1996), all of which are incorporated by reference). Other analog nucleic acids include those with positive backbones (Denpcy et al., Proc. Natl. Acad. Sci. USA 92:6097 (1995); non-ionic backbones (U.S. Pat. Nos. 5,386,023, 5,637,684, 5,602,240, 5,216,141 and 4,469,863; Kiedrowshi et al., Angew. Chem. Intl. Ed. English 30:423 (1991); Letsinger et al., J. Am. Chem. Soc. 110:4470 (1988); Letsinger et al., Nucleoside & Nucleotide 13:1597 (1994); Chapters 2 and 3, ASC Symposium Series 580, “Carbohydrate Modifications in Antisense Research”, Ed. Y. S. Sanghui and P. Dan Cook; Mesmaeker et al., Bioorganic & Medicinal Chem. Lett. 4:395 (1994); Jeffs et al., J. Biomolecular NMR 34:17 (1994); Tetrahedron Lett. 37:743 (1996)) and non-ribose backbones, including those described in U.S. Pat. Nos. 5,235,033 and 5,034,506, and Chapters 6 and 7, ASC Symposium Series 580, “Carbohydrate Modifications in Antisense Research”, Ed. Y. S. Sanghui and P. Dan Cook. Nucleic acids containing one or more carbocyclic sugars are also included within the definition of nucleic acids (see Jenkins et al., Chem. Soc. Rev. (1995) pp 169-176). Several nucleic acid analogs are described in Rawls, C & E News Jun. 2, 1997 page 35. All of these references are hereby expressly incorporated by reference. These modifications of the ribose-phosphate backbone may be done to facilitate the addition of additional moieties such as labels, or to increase the stability and half-life of such molecules in physiological environments.

As will be appreciated by those in the art, all of these nucleic acid analogs may find use in the present invention. In addition, mixtures of naturally occurring nucleic acids and analogs can be made. Alternatively, mixtures of different nucleic acid analogs, and mixtures of naturally occuring nucleic acids and analogs may be made.

The nucleic acids may be single stranded or double stranded, as specified, or contain portions of both double stranded or single stranded sequence. The nucleic acid may be DNA, both genomic and cDNA, RNA or a hybrid, where the nucleic acid contains any combination of deoxyribo- and ribonucleotides, and any combination of bases, including uracil, adenine, thymine, cytosine, guanine, inosine, xathanine hypoxathanine, isocytosine, isoguanine, etc. As used herein, the term “nucleoside” includes nucleotides and nucleoside and nucleotide analogs, and modified nucleosides such as amino modified nucleosides. In addition, “nucleoside” includes non-naturally occuring analog structures. Thus for example the individual units of a peptide nucleic acid, each containing a base, are referred to herein as a nucleoside.

As described above generally for proteins, nucleic acid candidate bioactive agents may be naturally occuring nucleic acids, random nucleic acids, or “biased” random nucleic acids. For example, digests of procaryotic or eucaryotic genomes may be used as is outlined above for proteins. Where the ultimate expression product is a nucleic acid, at least 10, preferably at least 12, more preferably at least 15, most preferably at least 21 nucleotide positions need to be randomized, with more preferable if the randomization is less than perfect. Similarly, at least 5, preferably at least 6, more preferably at least 7 amino acid positions need to be randomized; again, more are preferable if the randomization is less than perfect.

In a preferred embodiment, the candidate bioactive agents are organic moieties. In this embodiment, as is generily described in WO 94/24314, candidate agents are synthesized from a series of substrates that can be chemically modified. “Chemically modified” herein includes traditional chemical reactions as well as enzymatic reactions. These substrates generally include, but are not limited to, alkyl groups (including alkanes, alkenes, alkynes and heteroalkyl), aryl groups (including arenes and heteroaryl), alcohols, ethers, amines, aldehydes, ketones, acids, esters, amides, cyclic compounds, aeterocyclic compounds (including purines, pyrimidines, benzodiazepins, beta-lactams, tetracylines, ephalosporins, and carbohydrates), steroids (including estrogens, androgens, cortisone, ecodysone, atc.), alkaloids (including ergots, vinca, curare, pyrollizdine, and mitomycines), organomet allic compounds, hetero-atom bearing compounds, amino acids, and nucleosides. Chemical (including enzymatic) reactions may be done on the moieties to form new substrates or candidate agents which can then be tested using the present invention.

As will be appreciated by those in the art, it is possible to screen more than one type of candidate agent at a time. Thus, the library of candidate agents used in any particular assay may include only one type of agent (i.e. peptides), or multiple types (peptides and organic agents).

Thus, in a preferred embodiment, the invention provides biochips comprising variant libraries of at east one scaffold protein, and methods of screening utilizing the biochips. Thus, for example, the invention provides completely defined libraries of variant scaffold proteins having a defined set number, wherein at least 85-90-95% of the possible members are present in the library.

I addition, as will also be appreciated by those in the art, the biochips of the invention may be part of HTS system utilizing any number of components. Fully robotic or microfluidic systems include automated liquid-, particle-, cell- and organism-handling including high throughput pipetting to perform all steps of gene targeting and recombination applications. This includes liquid, particle, cell, and organism manipulations such as aspiration, dispensing, mixing, diluting, washing, accurate volumetric transfers; retrieving, and discarding of pipes tips; and repetitive pipetting of identical volumes for multiple deliveries from a single sample aspiration. These manipulations are cross-contamination-free liquid, particle, cell, and organism transfers. This instrument performs automated replication of microplate samples to filters, membranes, and/or daughter plates, high-density transfers, full-plate serial dilutions, and high capacity operation.

The system used can include a computer workstation comprising a microprocessor programmed to manipulate a device selected from the group consisting of a thermocycler, a multichannel pipettor, a sample handler, a plate handler, a gel loading system, an automated transformation system, a gene sequencer, a colony picker, a bead picker, a cell sorter, an incubator, a light microscope, a fluorescence microscope, a spectrofluorimeter, a spectrophotometer, a luminometer, a CCD camera and combinations thereof.

In a preferred embodiment, the methods of the invention are used to generate variant libraries to facilitate and correlate single nucleotide polymorphism (SNP) analysis. That is, by drawing on known SNP data and determining the effect of the SNP on the protein, information concerning SNP analysis can be determined. Thus, for example, making a “sequence alignment” of sorts using known SNPs can result in a probability distribution table that can be used to design all possible SNP variants, which can then be put on a biochip and tested for activity and effect.

The following examples serve to more fully describe the manner of using the above-described invention, as well as to set forth the best modes contemplated for carrying out various aspects of the invention. It is understood that these examples in no way serve to limit the true scope of this invention, but rather are presented for illustrative purposes. All references cited herein are incorporated by reference.

### EXAMPLES

### Example 1

### Protein Design Using Ensemble Averaging and Mean Field Free Energies

The most direct application of the invention is the design of a single protein sequence with the goal that the sequence, when produced experimentally, spontaneously adopts the target three-dimensional structure. To illustrate this process, the small protein motif typical of proteins in the WW family of protein domains was taken as a target structure.

In a preferred embodiment of the invention, the ensemble-averaging/mean field method utilizes a set of structurally similar protein backbones as input for the design process. In this manner, the degrees of freedom that are physically expected of a backbone can be taken into account directly. Furthermore, the extent of flexibility allowed in such a backbone can be explored to generate different results. In the present example, the ensemble of backbones was generated by a Monte Carlo procedure. Beginning with a single backbone structure taken from published coordinates of the Pin1 protein (Ranganathan et al., 1997), the Monte Carlo procedure, which operated by perturbing the backbone dihedral angles, was applied repeatedly to generate a series of backbone structures that had a root mean squared deviation from the original structure of 0.3 angstroms. Because of the stochastic nature of the Monte Carlo procedure, each of the resultant backbone structures is unique.

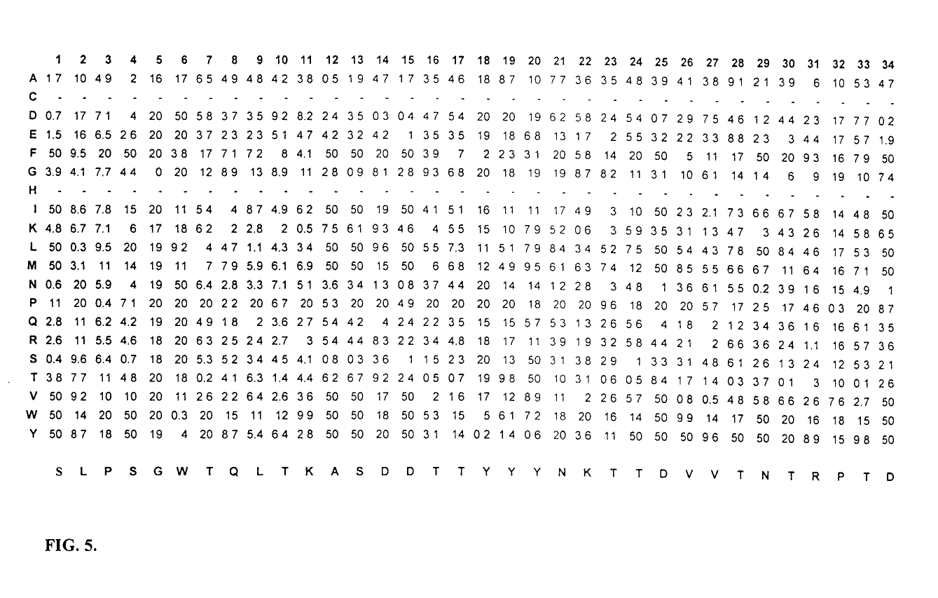

The ensemble averaging/mean field method, as outlined in FIG. 2, was applied to the input backbone ensemble to determine a mean field free energy matrix representing the suitability of all amino acids (excluding Cysteine and Histidine) and rotamer states at all positions in the structure. As is known in the art, a lower free energy value represents a higher suitability of the given amino acid/rotamer combination. The SPA program and scoring function, as highlighted above, was used for the design and all evaluation steps. For each major cycle of the procedure (represented by cycle / in FIG. 2), results from 30 representative backbone structures (m cycle in FIG. 2) were thermodynamically averaged to yield a final free energy matrix. Three major cycles were performed to ensure self-consistency in the results. A portion of the final free energy matrix, representing the lowest free energy rotamer state of each amino acid type at all positions, is shown in FIG. 5.

The free energy matrix can be utilized in a number of ways. In the present example, the matrix is used to choose a single protein sequence for production in the laboratory. Hence, the amino acid with the lowest free energy value at each position in the structure is used to design the protein.

A designed WW protein, consisting of 34 optimal amino acids from the final free energy matrix of FIG. 5, was produced in the laboratory using well-known methods, as follows. First, a set of overlapping synthetic DNA oligonucleotides encoding the designed protein were ordered from a commercial provider and purified by polyacrylamide gel electrophoresis. These oligonucleotides were assembled, again using well-known methods, as a fusion with a gene that encodes the N-terminal domain of calmodulin (N-cam), which acts as a convenient fusion partner for expression and purification of the desired protein. Any number of useful reporter proteins or purification tags, including but not limited to epitope tags, fluorescent proteins such as gfp could also be used as fusion partners. The N-cam-WW protein fusion was expressed in E. coli bacterial cells using well-known methods and subsequently purified by phenyl-sepharose chromatography. The purified fusion protein was then cleaved by the Nla protease to yield the designed WW domain, which was then further purified by high performance liquid chromatography.

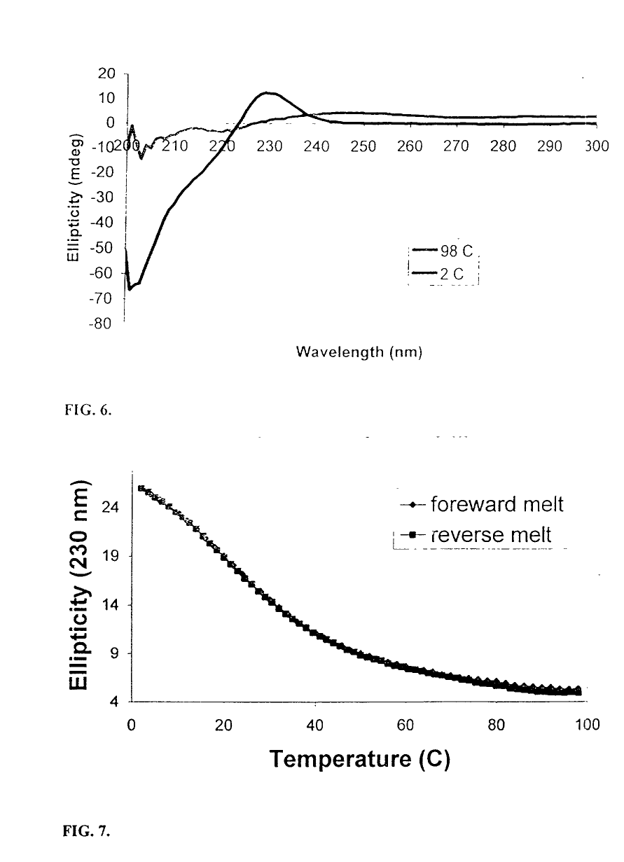

The purified form of the designed WW domain was characterized by Circular Dichroism (CD) spectroscopy. FIG. 6 shows CD spectra collected for the designed WW protein at 2□ C and 98□ C. The spectra reveal that at lower temperatures, the protein is folded into a structure that is related to the target structure, judging from the fact that the positive peak observed in the low temperature spectrum at approximately 230 nm is also observed in the natural protein (not shown). While the true structure cannot be directly known without further experimental characterization, those in the art will appreciate that a positive CD signal at 230 nm is rare for proteins, and that its existence in the spectrum of the designed protein is compelling evidence of structural similarity to the target.

A thermal denaturation of the designed WW domain was also performed while monitoring the CD signal at 230 nm. A clear sigmoidal transition from folded to unfolded protein is observed. Furthermore, a thermal renaturation experiment over the same temperature range yields identical behavior. As is known in the art, these behaviors are consistent with a cooperatively folded protein domain.

In summary, these sets of data strongly suggest that the new WW domain protein designed using the invention spontaneously adopts the desired three-dimensional structure, and has properties expected of a natural protein. As will be appreciated by those in the art, this designed protein represents one of a very small number of proteins that have been successfully designed by a fully automated protein design procedure. As will also be appreciated in the art, this protein is composed predominantly of _-sheet secondary structure, a type of structure that has proven difficult to design successfully.

### Example 2

### Designing Combinatorial Libraries of Proteins

An important extension of protein design algorithms is their use to guide the rational design and construction of combinatorial libraries. Such libraries can be produced genetically in the laboratory, then screened or selected for desired properties as previously described herein. Desired properties can include, but are not limited to, enhanced catalytic activity, improved stability, altered specificity, and enhanced activity/stability under extreme conditions. Alternatively in certain circumstances, it may be desired to remove or attenuate a selected protein function (i.e., enzymatic activity etc.) which can be effected by appropriate protein design as described herein. Combinatorial libraries and the molecular diversity they represent are of extreme importance in the biotechnology arena. However, their use has not been explored in depth, so an ability to control the extent and type of diversity encoded by a library is paramount to further developments in the field.

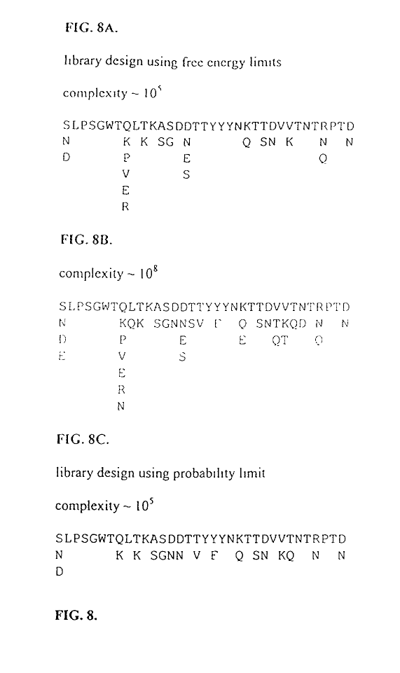

A unique feature of a complete mean field free energy matrix is the ability to control the extent and type of diversity of a corresponding combinatorial library. The simplest method for library design is to slowly increase an upper limit on the allowed free energy scale, incorporating any amino acids that fall within the allowed range into the combinatorial library. Once the desired level of complexity is achieved, the procedure is stopped. The complexity of a library is defined simply as the product of the number of amino acids allowed at each position of the structure. FIG. 8A shows a combinatorial library constructed for the WW motif, using the free energy matrix that was derived in Example 1, and the simple free energy scaling method. The library was constructed to have a complexity of approximately 10⁵. To illustrate the flexibility of options available when a complete free energy matrix exists, the complexity of the library is increased further by simply raising the upper limit on free energy, as in FIG. 8B, where the combinatorial library is constructed to have a complexity of approximately 10⁸.

An alternative procedure to the construction of combinatorial libraries is to slowly decrease a lower limit on the normalized probability of each amino acid at each position in the structure. As is known in the art, the normalized probability p_{x,i} of amino acid type x at position i can be related directly to the free energy A_{x,i} by the relationship

$${p}_{x , i} = \frac{{ⅇ}^{- {A}_{x i} / RT}}{{\sum }_{x = 1}^{20} {ⅇ}^{- {A}_{x i} / RT}}$$

FIG. 8C shows a combinatorial library designed using a procedure in which amino acids are incorporated into the library at incrementally lower probability, beginning with the highest probability amino acids at each position (corresponding to the sequence characterized in Example 1). The procedure was ceased when a complexity of 10⁵ was achieved, so that the library can be compared directly to that in FIG. 8A. Importantly, the nature of the two libraries are significantly different. For instance, note that the latter procedure results in a more even distribution of the complexity throughout the protein, whereas the former procedure focuses the diversity at a smaller number of positions. It should be emphasized that it is presently unknown which type of library will lead to more successful production of proteins in the laboratory. It is likely that different procedures such as those highlighted here will find optimal use in different applications.

It should be understood that this level of control over combinatorial library design far exceeds that obtained by application of a typical protein design algorithm. Table 1 shows a comparison between a probability matrix derived by repeated application of the SPA program as outlined in FIG. 3 and a probability matrix derived in accordance with the present invention as outlined in FIG. 2. In the former case, a simple list of amino acid frequencies of occurrence would be created. This list would constitute an incomplete view (question marks in Table 1) of the diversity of amino acids that are allowed for the structure. For example, multiple applications of a typical protein design algorithm suggest that a Thr at position 7 is very likely, and that the suitability of Val at the same position is unknown. However, the present invention reveals that Val, while less probable than Thr, should be considered seriously for incorporation into a combinatorial library.

TABLE 1

| | multiple sequence design^{a} | | | | | | | | present invention^{b} | | | | | | | |
|---|---|---|---|---|---|---|---|---|---|---|---|---|---|---|---|---|
| | 1 | 2 | 3 | 4 | 5 | 6 | 7 | 8 | 1 | 2 | 3 | 4 | 5 | 6 | 7 | 8 |
| Ala | 3 | ? | 15 | ? | ? | ? | ? | 6 | 10.5 | 0.4 | 6.8 | 17.3 | 0.0 | 0.0 | 2.0 | 2.8 |
| Asp | 39 | ? | ? | 11 | ? | ? | ? | ? | 17.3 | 0.0 | 2.3 | 6.4 | 0.0 | 0.0 | 2.8 | 5.2 |
| Glu | 2 | ? | ? | 1 | ? | ? | 8 | 16 | 11.6 | 0.0 | 3.1 | 12.8 | 0.0 | 0.0 | 8.1 | 10.4 |
| Phe | ? | ? | ? | ? | ? | 6 | 1 | 3 | 0.0 | 0.7 | 0.0 | 0.0 | 0.0 | 12.8 | 0.0 | 0.9 |
| Gly | ? | 33 | ? | ? | 100 | ? | ? | ? | 3.5 | 9.7 | 1.7 | 5.2 | 99.8 | 0.0 | 0.2 | 0.4 |
| Ile | ? | ? | ? | ? | ? | 2 | ? | ? | 0.0 | 1.0 | 1.6 | 0.0 | 0.0 | 0.4 | 3.4 | 4.5 |
| Lys | ? | ? | ? | ? | ? | ? | 1 | 12 | 2.2 | 2.6 | 2.3 | 2.3 | 0.0 | 0.0 | 2.3 | 12.1 |
| Leu | ? | 62 | ? | ? | ? | 7 | ? | 2 | 0.0 | 64.8 | 0.7 | 0.0 | 0.0 | 0.9 | 6.9 | 3.1 |
| Met | ? | 3 | ? | ? | ? | ? | ? | ? | 0.0 | 16.0 | 0.3 | 0.1 | 0.0 | 0.4 | 1.5 | 0.6 |
| Asn | 18 | ? | 1 | ? | ? | ? | ? | 2 | 18.2 | 0.0 | 4.1 | 6.4 | 0.0 | 0.0 | 2.1 | 8.1 |
| Pro | ? | ? | 81 | ? | ? | ? | ? | 20 | 0.1 | 0.0 | 64.5 | 1.4 | 0.0 | 0.0 | 0.0 | 10.9 |
| Gln | ? | ? | ? | ? | ? | ? | ? | 11 | 6.1 | 0.4 | 3.6 | 5.8 | 0.0 | 0.0 | 4.4 | 13.4 |
| Arg | ? | ? | ? | ? | ? | ? | ? | 16 | 6.7 | 0.4 | 5.0 | 4.7 | 0.0 | 0.0 | 2.2 | 9.4 |
| Ser | 37 | 1 | 3 | 88 | ? | ? | ? | 1 | 20.1 | 0.6 | 3.2 | 33.1 | 0.0 | 0.0 | 3.6 | 2.4 |
| Thr | ? | ? | ? | ? | ? | ? | 90 | ? | 3.7 | 1.6 | 0.4 | 4.3 | 0.0 | 0.0 | 46.4 | 4.2 |
| Val | ? | ? | ? | ? | ? | 2 | ? | 6 | 0.0 | 0.8 | 0.5 | 0.3 | 0.0 | 0.3 | 14.0 | 10.9 |
| Trp | ? | ? | ? | ? | ? | 65 | ? | ? | 0.0 | 0.1 | 0.0 | 0.0 | 0.0 | 73.6 | 0.0 | 0.0 |
| Tyr | ? | 1 | ? | ? | ? | 18 | ? | 4 | 0.0 | 1.0 | 0.0 | 0.0 | 0.0 | 11.6 | 0.0 | 0.4 |

^{a}Amino acid incorporation statistics from 90 applications of the SPA

Throughout the present disclosure, references are made to various publications, the complete titles and citations of which are appended herewith, all of which are hereby incorporated by reference in their entirety.

Although the invention describes in detail certain embodiments, it is understood that variations and modifications exist which are within the scope of the invention as set forth in the following claims.

We claim:

1. A method executed by a computer under the control of a program, said computer including a memory for storing said program, said method comprising the steps of:
a) inputting an ensemble of protein backbone scaffolds;
b) applying at least one protein design cycle to each of said scaffolds; and
c) generating a probability matrix derived from a plurality of variable sequences.

2. A method according to claim 1 wherein said protein design cycle comprises a sequence prediction algorithm.

3. A method according to claim 1 wherein said protein design cycle comprises a dead end elimination algorithm.

4. A method according to claim 1 wherein said protein design cycle comprises a genetic algorithm.

5. A method according to claim 1 wherein said protein design cycle comprises a Monte Carlo algorithm.

6. A method according to claim 1 wherein said protein design cycle comprises a self consistent mean field theory (SCMF) algorithm.

7. A method according to claim 1 wherein said protein design cycle comprises a Monte Carlo algorithm.

8. A method according to claim 1 further comprising ranking said variable sequences.

9. A method according to claim 1 further comprising synthesizing a plurality of said variable sequences.

10. A method according to claim 1 further comprising recombining a plurality of said variable sequences to form additional variable sequences.

11. A method according to claim 1 wherein said ensemble comprises a family of naturally occurring proteins.

12. A method according to claim 1 wherein said ensemble is generated by a Monte Carlo simulation.

13. A method according to claim 1 wherein said ensemble is generated by a Molecular Dynamics simulation.

14. A method according to claim 1 wherein said ensemble is derived from an NMR ensemble of structures.

15. A method according to claim 1 wherein after step a), a rotamer library is pre-filtered to eliminate high energy interactions to form a suitable rotamer set for each scaffold.

16. A method for optimizing simulation or scoring function parameters that utilizes comparisons between designed sequences and natural sequences, comprising the steps of:
a) applying a protein design cycle to produce a variable protein sequence;
b) comparing said variable protein sequence to at least one natural protein sequence and/or conformation;
c) modifying said simulation or scoring function parameters to reflect said comparison.

17. A method for optimizing simulation or scoring function parameters that utilizes comparisons between designed sequences and natural sequences, comprising the steps of:
a) applying a protein design cycle to produce an amino acid probability matrix;
b) comparing said matrix to at least one natural protein sequence and/or conformation;
c) modifying said simulation or scoring function parameters to reflect said comparison.
